(19) United States
(12) Patent Application Publication
(10) Pub. No.: US 2026/0135994 A1
(43) Pub. Date: May 14, 2026

(54) TEMPLATE-BASED CODING METHODS, APPARATUSES, AND STORAGE MEDIUMS FOR REFERENCE PICTURE RESAMPLING

(71) Applicant: BEIJING DAJIA INTERNET INFORMATION TECHNOLOGY CO., LTD., Beijing (CN)

(72) Inventors: Xiaoyu XIU, San Diego, CA (US); Hong-Jheng JHU, San Diego, CA (US); Che-Wei KUO, San Diego, CA (US); Changyue MA, San Diego, CA (US); Ning YAN, San Diego, CA (US); Wei CHEN, San Diego, CA (US); Xianglin WANG, San Diego, CA (US); Bing YU, Beijing (CN)

(73) Assignee: BEIJING DAJIA INTERNET INFORMATION TECHNOLOGY CO., LTD., Beijing (CN)

(21) Appl. No.: 19/434,401

(22) Filed: Dec. 29, 2025

Related U.S. Application Data
(63) Continuation of application No. PCT/US2024/036027, filed on Jun. 28, 2024.
(60) Provisional application No. 63/524,335, filed on Jun. 30, 2023.

(51) Int. Cl. H04N 19/105; H04N 19/159; H04N 19/176; H04N 19/192; H04N 19/573; H04N 19/577; H04N 19/82

(52) U.S. Cl. CPC H04N 19/105; H04N 19/159; H04N 19/176; H04N 19/573; H04N 19/577; H04N 19/82; H04N 19/192

(57) ABSTRACT

A method for video encoding, a method for video decoding, and apparatuses thereof are provided. RPR prediction samples may be determined for a video block from a video frame of a video based on one or more reference frames and motion information associated with the video block. At least one of the one or more reference frames has a resolution different from a resolution of the video frame. The RPR prediction samples may be filtered based on a template-based adaptive filter to generate filtered RPR prediction samples for the video block. A predictive block including the filtered RPR prediction samples may be determined for the video block.

### CROSS-REFERENCE TO RELATED APPLICATIONS

This application is a continuation of PCT Application No. PCT/US2024/036027, filed Jun. 28, 2024, which is based upon and claims priority to U.S. Provisional Application No. 63/524,335 filed Jun. 30, 2023, the content of which is incorporated herein by reference in its entirety.

### TECHNICAL FIELD

This application is related to video coding and compression. More specifically, this application relates to video processing apparatuses and methods for video coding based on reference picture resampling (RPR).

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. For example, video coding standards include Versatile Video Coding (VVC), Joint Exploration test Model (JEM), High-Efficiency Video Coding (HEVC/H.265), Advanced Video Coding (AVC/H.264), Moving Picture Expert Group (MPEG) coding, or the like. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

### SUMMARY

Implementations of the present disclosure provide a method for video decoding. The method may include determining, by a decoder, RPR prediction samples for a video block from a video frame of a video based on one or more reference frames and motion information associated with the video block. At least one of the one or more reference frames has a resolution different from a resolution of the video frame. The method may also include filtering, by the decoder, the RPR prediction samples based on a template-based adaptive filter to generate filtered RPR prediction samples for the video block. The method may further include determining, by the decoder, a predictive block including the filtered RPR prediction samples for the video block.

Implementations of the present disclosure provide a method for video encoding. The method may include determining, by an encoder, RPR prediction samples for a video block from a video frame of a video based on one or more reference frames and motion information associated with the video block. At least one of the one or more reference frames has a resolution different from a resolution of the video frame. The method may also include filtering, by the encoder, the RPR prediction samples based on a template-based adaptive filter to generate filtered RPR prediction samples for the video block. The method may further include determining, by the encoder, a predictive block including the filtered RPR prediction samples for the video block.

Implementations of the present disclosure also provide an apparatus for video decoding. The apparatus may include a memory configured to store a bitstream and a processor coupled to the memory. The processor may be configured to perform a method for video decoding disclosed herein to decode the bitstream.

Implementations of the present disclosure also provide an apparatus for video encoding. The apparatus may include a memory configured to store a bitstream and a processor coupled to the memory. The processor may be configured to perform a method for video encoding disclosed herein to generate the bitstream.

Implementations of the present disclosure also provide a non-transitory computer-readable storage medium having stored therein a bitstream, where the bitstream is decoded by a method for video decoding disclosed herein.

Implementations of the present disclosure also provide a non-transitory computer-readable storage medium having stored therein a bitstream, where the bitstream is generated by a method for video encoding disclosed herein.

It is to be understood that both the foregoing general description and the following detailed description are examples only and are not restrictive of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram illustrating an exemplary system for encoding and decoding video blocks in accordance with some implementations of the present disclosure.

FIG. 2 is a block diagram illustrating an exemplary video encoder in accordance with some implementations of the present disclosure.

FIG. 3 is a block diagram illustrating an exemplary video decoder in accordance with some implementations of the present disclosure.

FIGS. 4A-4E are block diagrams illustrating how a frame is recursively partitioned into multiple video blocks of different sizes and shapes in accordance with some implementations of the present disclosure.

FIG. 5 illustrates positions of spatial neighbors for a merge mode in accordance with some implementations of the present disclosure.

FIG. 6 illustrates candidate pairs for redundancy check in accordance with some implementations of the present disclosure.

FIG. 7A illustrates a temporal motion vector predictor (TMVP) derivation process in accordance with some implementations of the present disclosure.

FIG. 7B illustrates a diagram of candidate positions for a temporal candidate in accordance with some implementations of the present disclosure.

FIG. 8 illustrates example template-based coding schemes in accordance with some implementations of the present disclosure.

FIG. 9 illustrates a process of adaptive filtering for the RPR in accordance with some implementations of the present disclosure.

FIG. 10 illustrates a generation of prediction template samples for the RPR in accordance with some implementations of the present disclosure.

FIG. 11 is a flow chart of an exemplary method for video coding based on template-based coding schemes in accordance with some implementations of the present disclosure.

FIGS. 12A and 12B show a flow chart of an exemplary method for video encoding based on template-based coding schemes in accordance with some implementations of the present disclosure.

FIG. 13 shows a flow chart of an exemplary method for video decoding based on template-based coding schemes in accordance with some implementations of the present disclosure.

FIG. 14 is a diagram illustrating a computing environment coupled with a user interface, according to some implementations of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with digital video capabilities.

It should be understood that the terms “first.” “second,” and the like used in the description, claims of the present disclosure, and the accompanying drawings are used to distinguish objects, and not used to describe any specific order or sequence. It should be understood that the data used in this way may be interchanged under an appropriate condition, such that the embodiments of the present disclosure described herein may be implemented in orders besides those shown in the accompanying drawings or described in the present disclosure.

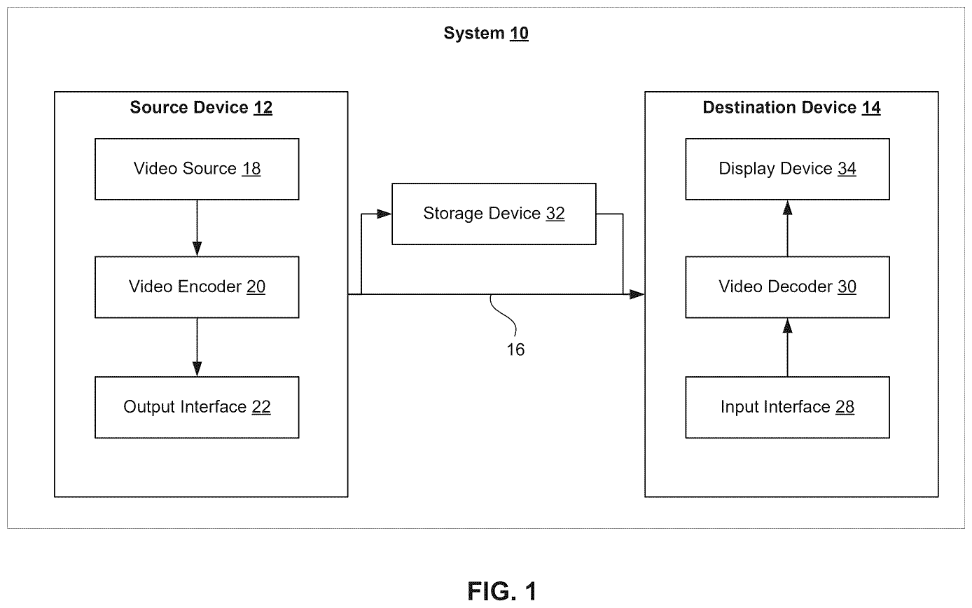

FIG. 1 is a block diagram illustrating an exemplary system 10 for encoding and decoding video blocks in parallel in accordance with some implementations of the present disclosure. As shown in FIG. 1, the system 10 includes a source device 12 that generates and encodes video data to be decoded at a later time by a destination device 14. The source device 12 and the destination device 14 may comprise any of a wide variety of electronic devices, including desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may comprise any type of communication medium or device capable of moving the encoded video data from the source device 12 to the destination device 14. In one example, the link 16 may comprise a communication medium to enable the source device 12 to transmit the encoded video data directly to the destination device 14 in real time. The encoded video data may be modulated according to a communication standard, such as a wireless communication protocol, and transmitted to the destination device 14. The communication medium may comprise any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may comprise any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

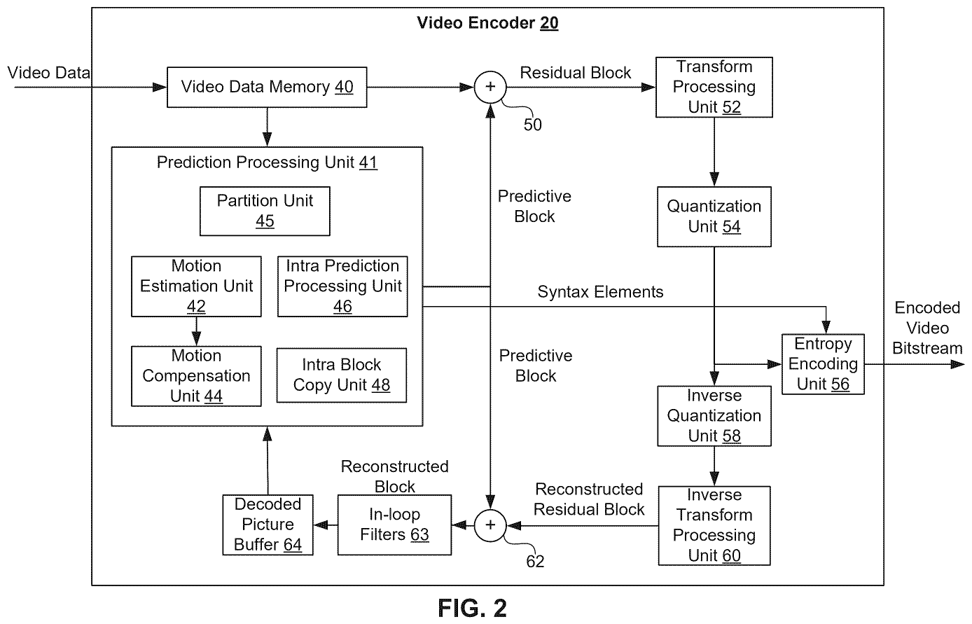

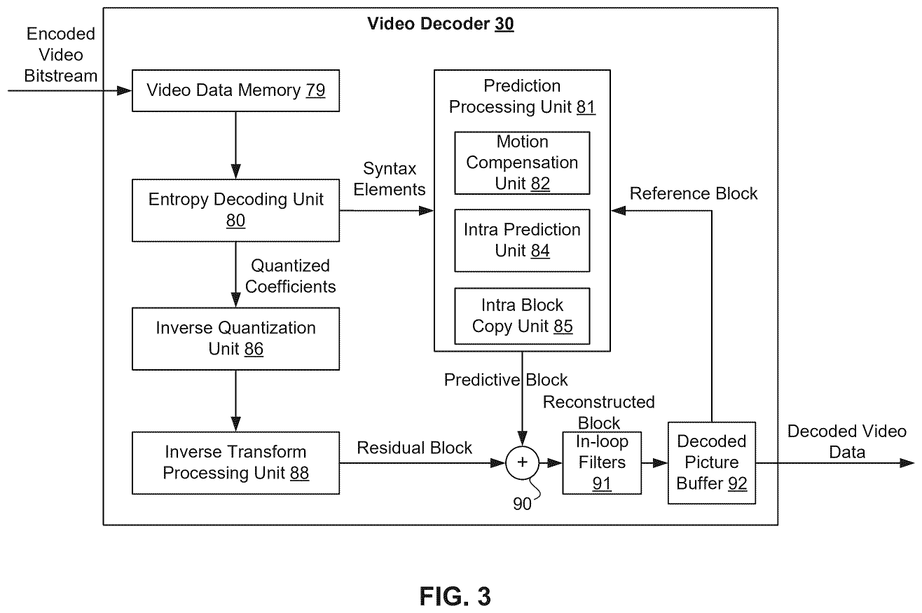

In some implementations, at least a part of components of the source device 12 (for example, the video source 18, the video encoder 20 or components included in the video encoder 20 as described below with reference to FIG. 2, and the output interface 22) and/or at least a part of components of the destination device 14 (for example, the input interface 28, the video decoder 30 or components included in the video decoder 30 as described below with reference to FIG. 3, and the display device 34) may operate in a cloud computing service network which may provide software, platforms, and/or infrastructure, such as Software as a Service (SaaS), Platform as a Service (PaaS), or Infrastructure as a Service (IaaS). In some implementations, one or more components in the source device 12 and/or the destination device 14 which are not included in the cloud computing service network may be provided in one or more client devices, and the one or more client devices may communicate with server computers in the cloud computing service network through a wireless communication network (for example, a cellular communication network, a short-range wireless communication network, or a global navigation satellite system (GNSS) communication network) or a wired communication network (e.g., a local area network (LAN) communication network or a power line communication (PLC) network). In an embodiment, at least a part of operations described herein may be implemented as cloud-based services provided by one or more server computers which are implemented by the at least a part of the components of the source device 12 and/or the at least a part of the components of the destination device 14 in the cloud computing service network; and one or more other operations described herein may be implemented by the one or more client devices. In some implementations, the cloud computing service network may be a private cloud, a public cloud, or a hybrid cloud. The terms such as “cloud,” “cloud computing,” “cloud-based” etc. herein may be used interchangeably as appropriate without departing from the scope of the present disclosure. It should be understood that the present disclosure is not limited to being implemented in the cloud computing service network described above. Instead, the present disclosure may also be implemented in any other type of computing environments currently known or developed in the future.

FIG. 2 is a block diagram illustrating an exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter, Cross Component Sample Adaptive Offset (CCSAO) filter and/or Adaptive in-Loop Filter (ALF), may also be used in addition to the deblocking filter to filter an output of the summer 62. It should be understood that for the CCSAO technique, the present application is not limited to the embodiments described herein, and instead, the application may be applied to a situation where an offset is selected for any of a luma component, a Cb chroma component and a Cr chroma component according to any other of the luma component, the Cb chroma component and the Cr chroma component to modify said any component based on the selected offset. Further, it should also be understood that a first component mentioned herein may be any of the luma component, the Cb chroma component and the Cr chroma component, a second component mentioned herein may be any other of the luma component, the Cb chroma component and the Cr chroma component, and a third component mentioned herein may be a remaining one of the luma component, the Cb chroma component and the Cr chroma component. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 2, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g. a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1, or archived in the storage device 32 as shown in FIG. 1 for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

FIG. 3 is a block diagram illustrating an exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 3. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter, CCSAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

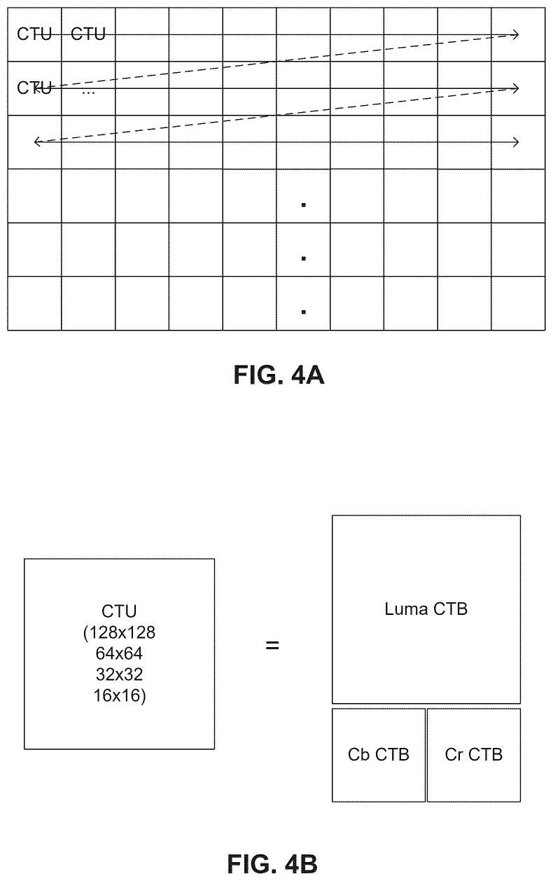

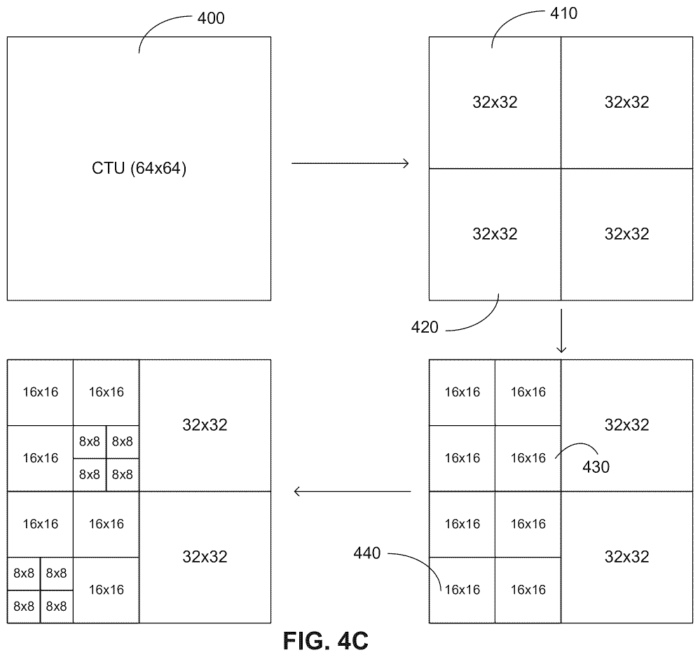

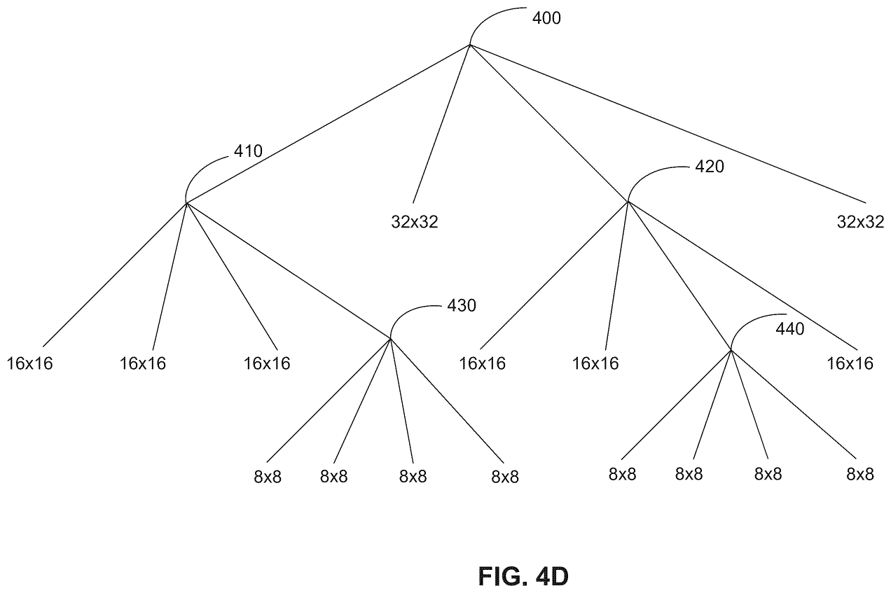

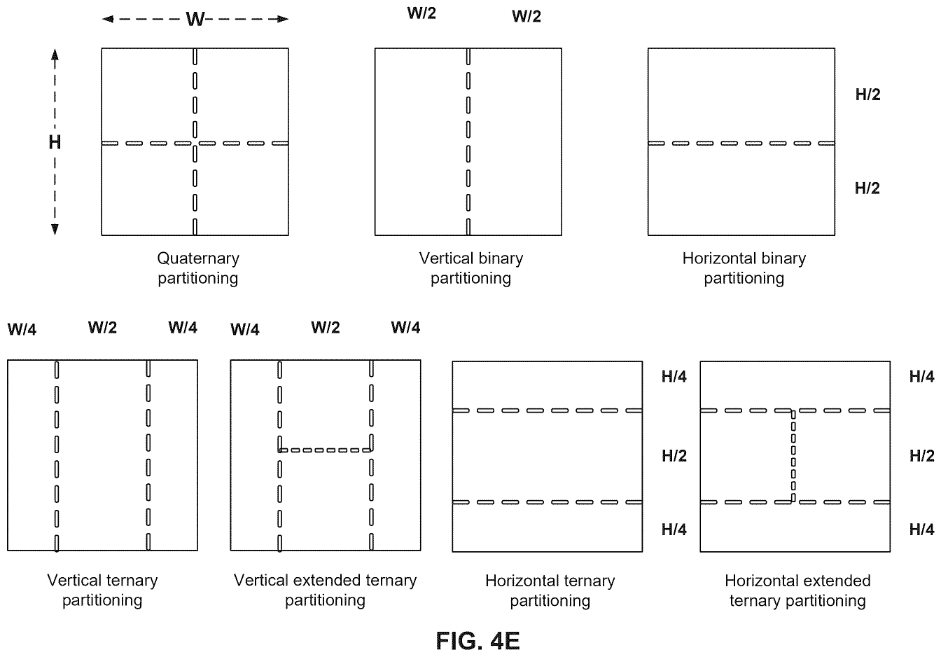

As shown in FIG. 4A, the video encoder 20 (or more specifically the partition unit 45) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 4B, each CTU may comprise one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may comprise a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 4C, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 4D depicts a quad-tree data structure illustrating the end result of the partition process of the CTU 400 as depicted in FIG. 4C, each leaf node of the quad-tree corresponding to one CU of a respective size ranging from 32×32 to 8×8. Like the CTU depicted in FIG. 4B, each CU may comprise a CB of luma samples and two corresponding coding blocks of chroma samples of a frame of the same size, and syntax elements used to code the samples of the coding blocks. In monochrome pictures or pictures having three separate color planes, a CU may comprise a single coding block and syntax structures used to code the samples of the coding block. It should be noted that the quad-tree partitioning depicted in FIGS. 4C and 4D is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 4E, there are seven possible partitioning types of a coding block having a width W and a height H, i.e., quaternary partitioning, horizontal binary partitioning, vertical binary partitioning, horizontal ternary partitioning, vertical ternary partitioning, horizontal extended ternary partitioning and vertical extended ternary partitioning.

In some implementations, the video encoder 20 may further partition a coding block of a CU into one or more M×N PBs. A PB is a rectangular (square or non-square) block of samples on which the same prediction, inter or intra, is applied. A PU of a CU may comprise a PB of luma samples, two corresponding PBs of chroma samples, and syntax elements used to predict the PBs. In monochrome pictures or pictures having three separate color planes, a PU may comprise a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 4C, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may comprise a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever-improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit 42 as described above in connection with FIG. 2, the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

A brief description of an inter advanced motion vector prediction (AMVP) mode is provided herein. In general, the motion information signaling in the VVC and the ECM is kept the same as that in the HEVC standard. Specifically, an inter prediction syntax, i.e., inter_pred_idc, is signaled to indicate whether the prediction signal is from a first reference picture list, a second reference picture, or both. The first reference picture list can be, for example, the reference frame list “List 0” (also referred to as “L0”). The second reference picture list can be, for example, the reference frame list “List 1” (also referred to as “L1”). For each used reference picture list, a corresponding reference frame is identified by signaling a reference picture index ref_idx_lx (e.g., x=0, or 1) for the corresponding reference picture list. A corresponding motion vector (MV) is represented by a motion vector predictor (MVP) index mvp_lx_flag (e.g., x=0, or 1) which is used to select a MVP, followed by a motion vector difference (MVD) between the corresponding MV and the selected MVP (e.g., MVD=MV−MVP). Additionally, a control flag mvd_l1_zero_flag is signaled at a slice level. When the control flag mvd_l1_zero_flag is equal to 0, the MVD associated with the reference picture list L1 (L1 MVD) is signaled in a bitstream. Otherwise (when the control flag mvd_l1_zero_flag is equal to 1), the L1 MVD is not signaled and its value is inferred to be zero at the encoder and decoder.

An affine AMVP mode may be applied to video blocks (e.g., CUs) with both a width and a height thereof being greater than or equal to 16. Specifically, when a block is coded with the affine mode, an affine flag is signaled to indicate whether the affine AMVP mode is used and then another flag is signaled to indicate whether a 4-parameter affine mode or a 6-parameter affine mode is used. In the affine AMVP mode, the differences between the best control point motion vectors (CPMVs) of the current CU and CPMVs selected from an affine AMVP candidate list may be signaled in the bitstream. For example, MVDs of the CPMVs may be signaled in the bitstream. An allowed maximum size of the affine AMVP candidate list is 2. Similar to non-affine AMVP mode, when the control flag mvd_l1_zero_flag is equal to 0, the MVDs of the CPMVs associated with the reference picture list L1 (L1 CPMVs) are signaled in the bitstream. Otherwise (when the mvd_l1_zero_flag flag is equal to 1), the MVDs of the L1 CPMVs are not signaled and their values are inferred to zero at the encoder and decoder.

A brief description of an inter merge mode is also provided herein. In the VVC, a regular inter merge candidate list is constructed by including one or more of the following five types of MVP candidates in order: (1) spatial MVPs from spatial neighbor CUs; (2) temporal MVPs from collocated CUs; (3) history-based MVPs from a first-in-first-out (FIFO) table; (4) pairwise average MVPs; or (5) zero MVPs. For each CU coded in the merge mode, an index of the best merge candidate is transmitted from the encoder to the decoder.

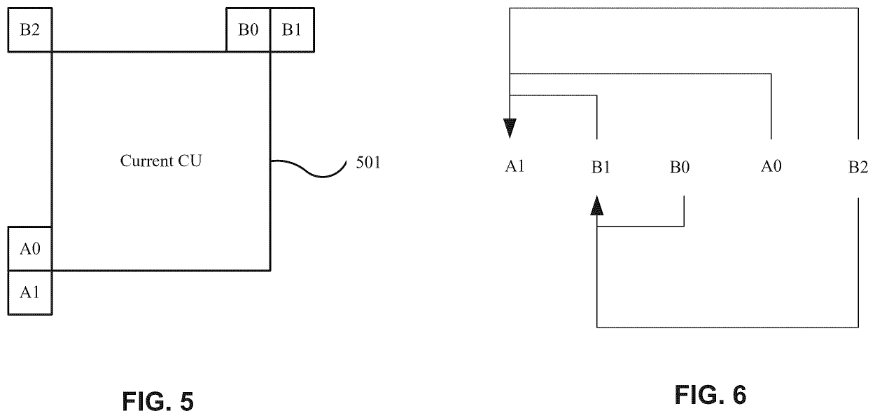

In some implementations, the derivation of MVPs from spatial candidates (for example, CUs neighboring a current CU 501 in FIG. 5) in VVC is the same as that in HEVC except that positions of the first two spatial candidates are swapped. A maximum of four spatial candidates are selected from spatial candidates located at positions depicted in FIG. 5, including a top position B0, a left position A0, a top-right position B1, a bottom-left position A1, and a top-left position B2. The derivation is performed in an order of CUs at the positions B0, A0, B1, A1, and B2 subsequently. A CU at the position B2 is considered only when one or more CUs at the positions B0, A0, B1, and A1 are not available (for example, the one or more CUs belonging to other slices or tiles and therefore being unavailable) or are intra coded.

After a CU at the position B0 is added as a candidate to a merge candidate list, the addition of the remaining candidates to the merge candidate list is subject to redundancy check, which ensures that candidates with the same motion information are excluded from the merge candidate list to improve coding efficiency. To reduce computational complexity, not all possible candidate pairs are considered in the redundancy check. Instead, only pairs linked using a line with an arrow in FIG. 6 are considered. For a candidate pair including a first candidate already added to the merge candidate list and a second candidate not added to the merge candidate list yet, the second candidate is added to the merge candidate list only if the first candidate in the pair used for the redundancy check does not have the same motion information as that of the second candidate. Spatial MVPs derived from the candidates in the merge candidate list are added to an MVP candidate list.

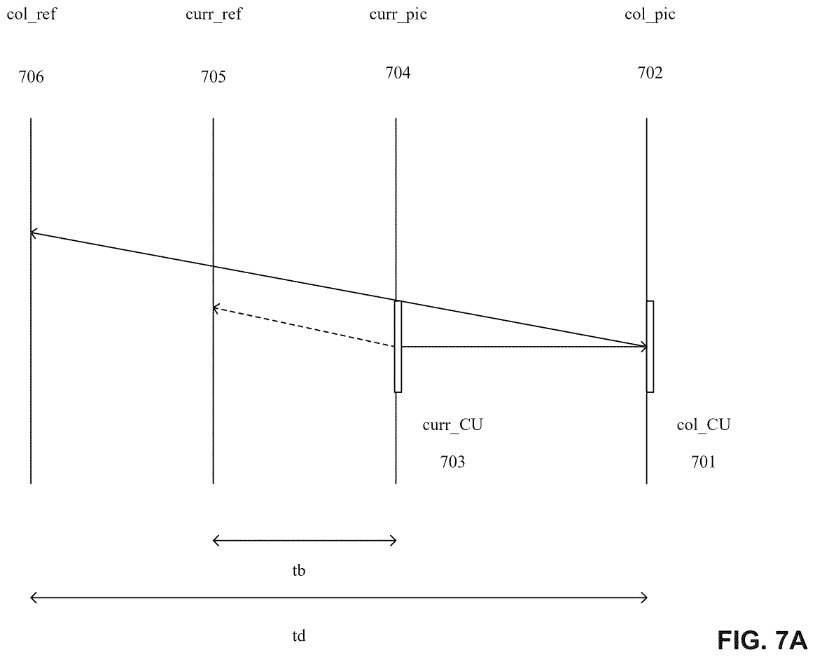

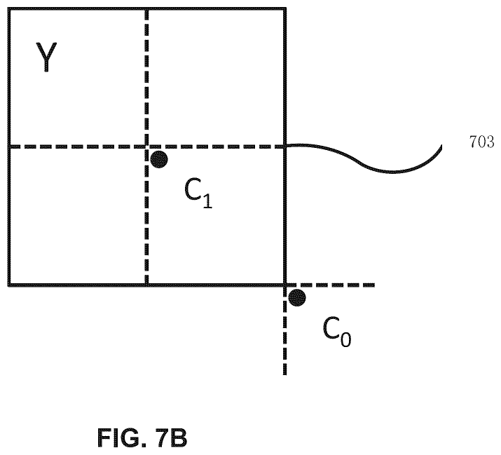

In some implementations, during the derivation of MVPs from temporal candidates, only one temporal candidate is added to the merge candidate list. Particularly, in the derivation of an MVP from this temporal candidate, a scaled motion vector is derived based on a collocated CU (e.g., col_CU 701 in FIG. 7A) because the temporal candidate belongs to a collocated picture (e.g., col_pic 702 in FIG. 7A) for a current CU (e.g., curr_CU 703 in FIG. 7A). The scaled motion vector is added as a temporal MVP candidate to the MVP candidate list. A reference picture list and a reference picture index to be used for the derivation of the collocated CU are explicitly signaled in a slice header. The scaled motion vector is obtained (i.e., scaled) from a motion vector of the collocated CU using Picture Order Count (POC) distances, i.e., tb and td, as illustrated in FIG. 7A, where tb denotes a POC difference between a reference picture (e.g., curr_ref 705 in FIG. 7A) of the current picture (e.g., curr_pic 704 in FIG. 7A) and the current picture, and td denotes a POC difference between a reference picture (e.g., col_ref 706 in FIG. 7A) of the collocated picture (e.g., col_pic 702) and the collocated picture. A reference picture index of the temporal candidate is set to be equal to zero.

A position for the temporal candidate (i.e., the collocated CU) in the current CU 703 is selected between positions C₀ and C₁, as depicted in FIG. 7B. If a CU at the position C₀ in the collocated picture is not available, or is intra coded, or is outside of the current row of CTUs, a CU at the position C₁ in the collocated picture is used as the collocated CU for the derivation of the temporal MVP candidate. Otherwise, a CU at the position C₀ in the collocated picture is used as the collocated CU for the derivation of the temporal MVP candidate.

In some implementations, history-based MVP (HMVP) candidates are added to the MVP candidate list after the spatial MVPs and the temporal MVP. Motion information of a previously coded block (e.g., a previously coded CU) is stored in an HMVP table and used as an MVP for the current CU. The HMVP table includes multiple HMVP candidates and is maintained during the encoding and/or decoding process. The HMVP table is reset (emptied) when a new row of CTUs is to be coded. When there is a non-subblock inter-coded CU, associated motion information is added to a last entry of the HMVP table as a new HMVP candidate.

A size of the HMVP table can be set to 6 or any other suitable integer. When a new HMVP candidate is inserted into the HMVP table, a constrained FIFO rule is utilized. For example, redundancy check is applied to determine whether there is an HMVP candidate in the HMVP table that is identical to the new HMVP candidate. If an HMVP candidate in the HMVP table is identical to the new HMVP candidate, the identical HMVP is removed from the HMVP table, and all the other HMVP candidates after the identical HMVP in the table are moved forward. The identical HMVP (equivalently, the new HMVP candidate) is added to the last entry of the HMVP table.

HMVP candidates may be used in a construction process of the MVP candidate list. The latest several HMVP candidates in the HMVP table are checked in order and inserted into the MVP candidate list after the temporal MVP candidate. Redundancy check is applied on the HMVP candidates relative to the spatial candidates and/or temporal MVP candidate.

To reduce the number of redundancy check operations, the following simplification operations may be performed. For example, the redundancy check may be performed for last two entries in the HMVP table relative to the spatial MVP candidates derived from the spatial candidates at the positions A1 and B1, respectively; and once a total number of available MVP candidates in the MVP candidate list reaches the maximum size of the MVP candidate list minus 1, the construction process of the MVP candidate list from the HMVP candidates is terminated.

In some implementations, pairwise average MVP candidates are generated by averaging MVPs derived using a predetermined pair of merge candidates in the current merge candidate list. A first merge candidate in the predetermined pair may be denoted as “p0Cand” and a second merge candidate in the predetermined pair may be denoted as “p1Cand”. Averaged motion vectors are calculated according to availability of motion vectors of “p0Cand” and “p1Cand” separately for each reference picture list. For example, for each reference picture list, if both motion vectors (e.g., motion vectors of “p0Cand” and “p1Cand”) are available for the reference picture list, these two motion vectors are averaged even when they point to different reference pictures, and a reference picture of the averaged motion vector is set to be a reference picture of “p0Cand.” If only one motion vector is available for the reference picture list, the only one motion vector is used directly as the averaged motion vector. If no motion vector is available for the reference picture list, the motion vector and the reference picture index for this reference picture list are kept invalid.

In some implementations, when the MVP candidate list is not full after the pairwise average MVP candidates are added to the list, zero MVPs are inserted at the end of the MVP candidate list until the allowed maximum size of the MVP candidate list is reached.

A brief description of reference picture resampling (RPR) is also provided herein. The VVC standard and the emerging ECM standard support fast spatial resolution switching within one bitstream. Such capability is referred to as RPR or adaptive resolution switch (ARC). In real-time video applications, allowing the resolution to be changed within a coded video sequence without the requirement of inserting a picture that supports random access, or Intra Random Access Point (IRAP) picture (e.g., an IDR picture, or an CRA picture etc.), can not only adapt the compressed video data to dynamic communication channel conditions, but also avoid the burst of bandwidth consumption due to the relatively large size of IDR or CRA pictures. Some example use cases that may benefit from the RPR feature are provided below.

A first example use case may include rate adaption in video telephony and conferencing (e.g., adapting a coded video to time-varying network conditions). For example, when a network condition gets worse so that the available bandwidth becomes lower, the encoder may adapt to the changed network condition by encoding pictures with smaller resolutions. Currently, changing picture resolution can be done only after an IRAP picture, resulting in one or more of the followings issues. For instance, an IRAP picture at reasonable quality is much larger than an inter-coded picture, and it is more complex to decode the IRAP picture, resulting in the high cost of time and resource. This can be a problem if the resolution change is requested by the decoder for loading reasons. It can also break low-latency buffer conditions (e.g., forcing an audio re-sync), and the end-to-end delay of the stream may increase (e.g., at least temporarily). As a result, the user experience is downgraded.

A second example use case may include active speaker changes in multi-party video conferencing. For multi-party video conferencing, it is common that an active speaker is shown in a bigger video size than the video for the rest of conference participants. When the active speaker changes, the picture resolution for each participant may also need to be adjusted. The need to have the ARC feature becomes more significant when such changes in active speakers happen frequently.

A third example use case may include fast start in streaming. For a streaming application, it is common that the application may buffer up to a certain length of decoded pictures before start displaying. Starting the bitstream with a smaller resolution may allow the application to have enough pictures in the buffer to start displaying faster.

A fourth example use case may include adaptive stream switching in streaming. The Dynamic Adaptive Streaming over HTTP (DASH) specification includes a feature named @mediaStreamStructureId. This enables switching between different representations at open-GOP random access points with non-decodable leading pictures, e.g., CRA pictures with associated RASL pictures in HEVC. When two different representations of the same video have different bitrates but the same spatial resolution while they have the same value of @mediaStreamStructureId, switching between the two representations at a CRA picture with associated RASL pictures can be performed. The RASL pictures associated with the switching-at CRA pictures can be decoded with acceptable quality, and therefore, seamless switching can be achieved. With ARC, the @mediaStreamStructureId feature may also be usable for switching between DASH representations with different spatial resolutions.

RPR high-level signaling is also provided herein. For example, according to an example RPR design, in the sequence parameter set (SPS), two syntax elements pic_width_max_in_luma_samples and pic_height_max_in_luma_samples are signaled to specify the maximum width and the maximum height of the coded pictures that refer to the SPS. Then, when the picture resolution is changed, a new picture parameter set (PPS) needs to be set when the related syntax elements pic_width_in_luma samples and pic_height_in_luma samples are signaled to specify the different picture resolutions of the pictures referring to the PPS. There is bitstream conformance such that the values of pic_width_in_luma_sample and pic_height_in_luma_sample may not exceed the values of pic_width_max_in_luma_samples and pic_height_max_in_luma_samples, respectively. The following Table 1 illustrates the RPR-related signaling in the SPS and PPS.

TABLE 1
the RPR signaling in the SPS and PPS

| | Descriptor |
|---|---|
| seq_parameter_set_rbsp( ) { | |
| ... | |
| pic_width_max_in_luma_samples | ue(v) |
| pic_height_max_in_luma_samples | ue(v) |
| ... | |
| } | |
| pic_parameter_set_rbsp( ) { | |
| ... | |
| pic_width_in_luma_samples | ue(v) |
| pic_height_in_luma_samples | ue(v) |
| ... | |
| } | |

A RPR process is also provided herein. Specifically, when there is a resolution change within a bitstream, a current video frame (e.g., a current picture) may be associated with one or more reference frames (e.g., reference pictures) in different sizes. According to an example RPR design, when picture resolution changes, all MVs to the current picture are normalized to the sample grid of the current picture instead of that of the reference pictures. This can make picture resolution changes transparent to the MV prediction process.

When the picture resolution changes, the MVs are scaled according to a resolution ratio between the current picture and the corresponding reference pictures. Additionally, the samples in a reference block (from the corresponding reference picture) associated with a current video block are up-sampled or down-sampled during the motion compensation of the current video block to generate a predictive block for the video block. In the VVC, a scaling ratio between the width of the reference picture and the width of the current picture and/or a scaling ratio between the height of the reference picture and the height of the current picture can be limited to a range of [1/8, 2].

In the example RPR design, different interpolation filters can be applied to interpolate reference samples when the current picture and its reference picture are in different resolutions. The reference samples may be samples in the reference picture. Specifically, when the resolution of the reference picture is equal to or smaller than that of the current picture, default 8-tap or 6-tap interpolation filters can be used to generate luma prediction samples of regular inter blocks and affine blocks, respectively, and default 4-tap interpolation filters can be used to generate chroma prediction samples of both regular inter blocks and affine blocks, as shown in Table 2 to Table 4 described below. However, the default motion interpolation filters do not present strong low-pass characteristics. When the resolution of the reference picture is higher than that of the current picture, using the default motion interpolation filters may lead to non-negligible aliasing, which becomes more severe when the down-sampling ratio is increased. Correspondingly, to improve the inter prediction efficiency of the RPR, different down-sampling filters can be applied when the reference picture has a higher resolution than that of the current picture. For instance, when the down-sampling ratio is equal to or greater than 1.5:1, corresponding 8-tap, 6-tap and 4-tap down-sampling filters as shown in Table 5 to Table 7 below can be used to generate the corresponding luma and chroma prediction samples of regular inter blocks and affine blocks.

TABLE 2
the RPR up-sampling filters used for luma
prediction of regular inter blocks

| Fractional | interpolation filter coefficients | | | | | | | |
|---|---|---|---|---|---|---|---|---|
| position | P0 | P1 | P2 | P3 | P4 | P5 | P6 | P7 |
| 1 | 0 | 1 | −3 | 63 | 4 | −2 | 1 | 0 |
| 2 | −1 | 2 | −5 | 62 | 8 | −3 | 1 | 0 |
| 3 | −1 | 3 | −8 | 60 | 13 | −4 | 1 | 0 |
| 4 | −1 | 4 | −10 | 58 | 17 | −5 | 1 | 0 |
| 5 | −1 | 4 | −11 | 52 | 26 | −8 | 3 | −1 |
| 6 | −1 | 3 | −9 | 47 | 31 | −10 | 4 | −1 |
| 7 | −1 | 4 | −11 | 45 | 34 | −10 | 4 | −1 |
| 8 | −1 | 4 | −11 | 40 | 40 | −11 | 4 | −1 |
| 9 | −1 | 4 | −10 | 34 | 45 | −11 | 4 | −1 |
| 10 | −1 | 4 | −10 | 31 | 47 | −9 | 3 | −1 |
| 11 | −1 | 3 | −8 | 26 | 52 | −11 | 4 | −1 |
| 12 | 0 | 1 | −5 | 17 | 58 | −10 | 4 | −1 |
| 13 | 0 | 1 | −4 | 13 | 60 | −8 | 3 | −1 |
| 14 | 0 | 1 | −3 | 8 | 62 | −5 | 2 | −1 |
| 15 | 0 | 1 | −2 | 4 | 63 | −3 | 1 | 0 |

TABLE 3
the RPR up-sampling filters used for
luma prediction of affine blocks

| | |
|---|---|
| Fractional | interpolation filter coefficients |

| position | P0 | P1 | P2 | P3 | P4 | P5 |
|---|---|---|---|---|---|---|
| 1 | 1 | −3 | 63 | 4 | −2 | 1 |
| 2 | 1 | −5 | 62 | 8 | −3 | 1 |
| 3 | 2 | −8 | 60 | 13 | −4 | 1 |
| 4 | 3 | −10 | 58 | 17 | −5 | 1 |
| 5 | 3 | −11 | 52 | 26 | −8 | 2 |
| 6 | 2 | −9 | 47 | 31 | −10 | 3 |
| 7 | 3 | −11 | 45 | 34 | −10 | 3 |
| 8 | 3 | −11 | 40 | 40 | −11 | 3 |
| 9 | 3 | −10 | 34 | 45 | −11 | 3 |
| 10 | 3 | −10 | 31 | 47 | −9 | 2 |
| 11 | 2 | −8 | 26 | 52 | −11 | 3 |
| 12 | 1 | −5 | 17 | 58 | −10 | 3 |
| 13 | 1 | −4 | 13 | 60 | −8 | 2 |
| 14 | 1 | −3 | 8 | 62 | −5 | 1 |
| 15 | 1 | −2 | 4 | 63 | −3 | 1 |

TABLE 4
the RPR up-sampling filters used for
chroma prediction of inter blocks

| | |
|---|---|
| Fractional | interpolation filter coefficients |

| sample | P0 | P1 | P2 | P3 |
|---|---|---|---|---|
| 1 | −1 | 63 | 2 | 0 |
| 2 | −2 | 62 | 4 | 0 |
| 3 | −2 | 60 | 7 | −1 |
| 4 | −2 | 58 | 10 | −2 |
| 5 | −3 | 57 | 12 | −2 |
| 6 | −4 | 56 | 14 | −2 |
| 7 | −4 | 55 | 15 | −2 |
| 8 | −4 | 54 | 16 | −2 |
| 9 | −5 | 53 | 18 | −2 |
| 10 | −6 | 52 | 20 | −2 |
| 11 | −6 | 49 | 24 | −3 |
| 12 | −6 | 46 | 28 | −4 |
| 13 | −5 | 44 | 29 | −4 |
| 14 | −4 | 42 | 30 | −4 |
| 15 | −4 | 39 | 33 | −4 |
| 16 | −4 | 36 | 36 | −4 |
| 17 | −4 | 33 | 39 | −4 |
| 18 | −4 | 30 | 42 | −4 |
| 19 | −4 | 29 | 44 | −5 |
| 20 | −4 | 28 | 46 | −6 |
| 21 | −3 | 24 | 49 | −6 |
| 22 | −2 | 20 | 52 | −6 |
| 23 | −2 | 18 | 53 | −5 |
| 24 | −2 | 16 | 54 | −4 |
| 25 | −2 | 15 | 55 | −4 |
| 26 | −2 | 14 | 56 | −4 |
| 27 | −2 | 12 | 57 | −3 |
| 28 | −2 | 10 | 58 | −2 |
| 29 | −1 | 7 | 60 | −2 |
| 30 | 0 | 4 | 62 | −2 |
| 31 | 0 | 2 | 63 | −1 |

TABLE 5
the RPR down-sampling filters used for luma prediction
of regular inter blocks when down-sampling ratio
is equal to or greater than 1.5:1

| | |
|---|---|
| Fractional | interpolation filter coefficients |

| sample | P0 | P1 | P2 | P3 | P4 | P5 | P6 | P7 |
|---|---|---|---|---|---|---|---|---|
| 0 | −1 | −5 | 17 | 42 | 17 | −5 | −1 | 0 |
| 1 | 0 | −5 | 15 | 41 | 19 | −5 | −1 | 0 |
| 2 | 0 | −5 | 13 | 40 | 21 | −4 | −1 | 0 |
| 3 | 0 | −5 | 11 | 39 | 24 | −4 | −2 | 1 |
| 4 | 0 | −5 | 9 | 38 | 26 | −3 | −2 | 1 |
| 5 | 0 | −5 | 7 | 38 | 28 | −2 | −3 | 1 |
| 6 | 1 | −5 | 5 | 36 | 30 | −1 | −3 | 1 |
| 7 | 1 | −4 | 3 | 35 | 32 | 0 | −4 | 1 |
| 8 | 1 | −4 | 2 | 33 | 33 | 2 | −4 | 1 |
| 9 | 1 | −4 | 0 | 32 | 35 | 3 | −4 | 1 |
| 10 | 1 | −3 | −1 | 30 | 36 | 5 | −5 | 1 |
| 11 | 1 | −3 | −2 | 28 | 38 | 7 | −5 | 0 |
| 12 | 1 | −2 | −3 | 26 | 38 | 9 | −5 | 0 |
| 13 | 1 | −2 | −4 | 24 | 39 | 11 | −5 | 0 |
| 14 | 0 | −1 | −4 | 21 | 40 | 13 | −5 | 0 |
| 15 | 0 | −1 | −5 | 19 | 41 | 15 | −5 | 0 |

TABLE 6
the RPR down-sampling filters used for luma prediction of affine
blocks when down-sampling ratio is equal to or greater than 1.5:1

| | |
|---|---|
| Fractional | interpolation filter coefficients |

| sample | P0 | P1 | P2 | P3 | P4 | P5 |
|---|---|---|---|---|---|---|
| 0 | −4 | 17 | 42 | 17 | −5 | −1 |
| 1 | −5 | 15 | 41 | 19 | −5 | −1 |
| 2 | −5 | 13 | 40 | 21 | −4 | −1 |
| 3 | −5 | 11 | 39 | 24 | −4 | −1 |
| 4 | −5 | 9 | 38 | 26 | −3 | −1 |
| 5 | −5 | 7 | 38 | 28 | −2 | −2 |
| 6 | −4 | 5 | 36 | 30 | −1 | −2 |
| 7 | −3 | 3 | 35 | 32 | 0 | −3 |
| 8 | −3 | 2 | 33 | 33 | 2 | −3 |
| 9 | −3 | 0 | 32 | 35 | 3 | −3 |
| 10 | −2 | −1 | 30 | 36 | 5 | −4 |
| 11 | −2 | −2 | 28 | 38 | 7 | −5 |
| 12 | −1 | −3 | 26 | 38 | 9 | −5 |
| 13 | −1 | −4 | 24 | 39 | 11 | −5 |
| 14 | −1 | −4 | 21 | 40 | 13 | −5 |
| 15 | −1 | −5 | 19 | 41 | 15 | −5 |

TABLE 7
the RPR down-sampling filters used for chroma prediction of inter
blocks when down-sampling ratio is equal to or greater than 1.5:1

| | |
|---|---|
| Fractional | interpolation filter coefficients |

| sample | P0 | P1 | P2 | P3 |
|---|---|---|---|---|
| 0 | 12 | 40 | 12 | 0 |
| 1 | 11 | 40 | 13 | 0 |
| 2 | 10 | 40 | 15 | −1 |
| 3 | 9 | 40 | 16 | −1 |
| 4 | 8 | 40 | 17 | −1 |
| 5 | 8 | 39 | 18 | −1 |
| 6 | 7 | 39 | 19 | −1 |
| 7 | 6 | 38 | 21 | −1 |
| 8 | 5 | 38 | 22 | −1 |
| 9 | 4 | 38 | 23 | −1 |
| 10 | 4 | 37 | 24 | −1 |
| 11 | 3 | 36 | 25 | 0 |
| 12 | 3 | 35 | 26 | 0 |
| 13 | 2 | 34 | 28 | 0 |
| 14 | 2 | 33 | 29 | 0 |
| 15 | 1 | 33 | 30 | 0 |
| 16 | 1 | 31 | 31 | 1 |
| 17 | 0 | 30 | 33 | 1 |
| 18 | 0 | 29 | 33 | 2 |
| 19 | 0 | 28 | 34 | 2 |
| 20 | 0 | 26 | 35 | 3 |
| 21 | 0 | 25 | 36 | 3 |
| 22 | −1 | 24 | 37 | 4 |
| 23 | −1 | 23 | 38 | 4 |
| 24 | −1 | 22 | 38 | 5 |
| 25 | −1 | 21 | 38 | 6 |
| 26 | −1 | 19 | 39 | 7 |
| 27 | −1 | 18 | 39 | 8 |
| 28 | −1 | 17 | 40 | 8 |
| 29 | −1 | 16 | 40 | 9 |
| 30 | −1 | 15 | 40 | 10 |
| 31 | 0 | 13 | 40 | 11 |

Although the RPR functionality is supported in the VVC and the ECM, its coding performance is not optimal. This is because the temporal neighboring pictures in different resolutions may present statistical characteristics. For example, when a video block is predicted from a reference frame with a larger resolution than that of a current video frame, prediction samples of the video block may usually have obvious aliasing artifacts because of the Nyquist-Shannon sampling theorem. Therefore, the efficiency of some inter coding tools, which aim at exploring the correlation between the temporal frames with the same resolution, may not be equally efficient for the RPR.

On the other hand, template matching (TM) based approaches have become an important topic in the recent development of video coding technologies. Specifically, by exploiting the computational capabilities at the decoder, the methods utilize the correlation between a video block and its neighboring reconstructed samples to model complex signal redundancies that exist in inter prediction. For example, an example TM-based scheme (also referred to as TM-based motion vector derivation) performs a distortion-guided search between a template (i.e., adjacent reconstruction samples) and reconstructed samples in the reference pictures in order to obtain inter prediction samples without the transmission of motion information.

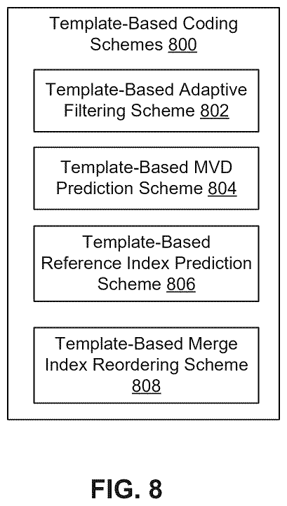

Consistent with some aspects of the present disclosure, the coding efficiency of motion compensated prediction in the RPR can be improved with the application of template-based coding schemes. Specifically, with reference to FIG. 8, template-based coding schemes 800 may include a template-based adaptive filtering scheme 802, a template-based MVD prediction scheme 804, a template-based reference index prediction scheme 806, and a template-based merge index reordering scheme 808. For example, when prediction samples for a video block of a current video frame is predicted from at least one temporal reference frame having a resolution different from that of the current video frame, template-based adaptive filtering scheme 802 may be applied to improve the quality of the prediction samples. Filter coefficients of a template-based adaptive filter in scheme 802 can be derived based on template samples of the video block to reduce the signaling overhead. In another example, template-based MVD prediction scheme 804 and template-based reference index prediction scheme 806 may be applied to reduce the signaling overhead of the motion information associated with reference pictures that are in different resolutions compared to the current video frame. In yet another example, template-based merge index reordering scheme 808 may be applied to reduce the signaling overhead of the merge mode when the candidates in the merge candidate list are associated with reference pictures with different resolutions.

As discussed above, compared to the regular motion compensated prediction, prediction samples obtained from temporal reference frames with varying resolutions may present different characteristics statistically (e.g., these prediction samples can be referred to as RPR prediction samples). Such difference may lead to poor quality of the RPR prediction samples when compared to prediction samples obtained from the regular motion compensation (i.e., prediction samples generated from temporal reference frames with the same resolution as the current video frame).

Consistent with some aspects of the present disclosure, template-based adaptive filtering scheme 802 can be applied to enhance the RPR prediction samples for the video block. For example, the RPR prediction samples may be filtered based on a template-based adaptive filter to generate filtered RPR prediction samples for the video block. Then, a predictive block (also referred to as a prediction block) can be generated to include the filtered RPR prediction samples for the video block.

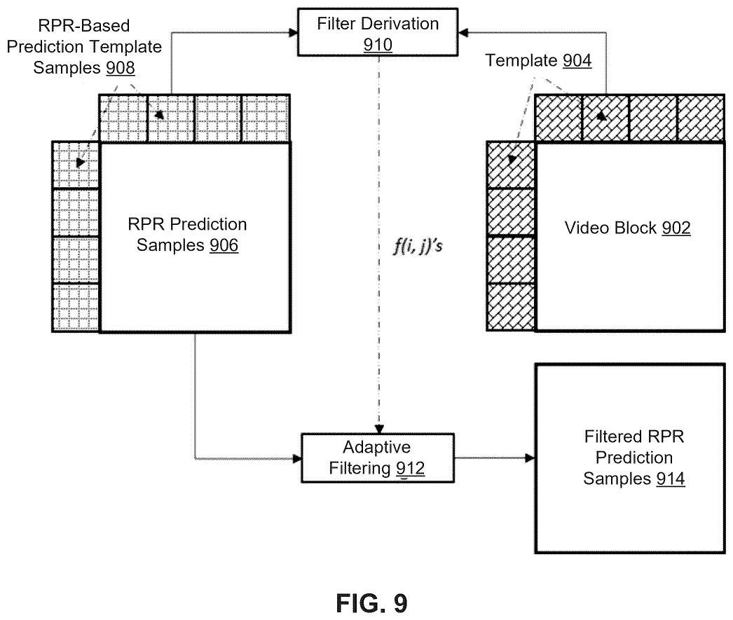

In some implementations, the RPR prediction samples for the video block can be determined based on one or more reference frames and one or more motion vectors associated with the video block. At least one of the one or more reference frames has a resolution different from a resolution of the video frame. Additionally, template samples of the video block may be determined. For example, template samples in a template of the video block may include (a) reconstructed samples above the video block and/or (b) reconstructed samples on the left of the video block (e.g., as depicted in FIG. 9, which is described below). Then, prediction template samples corresponding to the template samples may also be determined from the one or more reference frames based on the one or more motion vectors.

For example, a uni-prediction scheme can be applied to determine the RPR prediction samples for the video block. The RPR prediction samples may include uni-prediction samples determined from a reference frame based on a motion vector associated with the reference frame. The reference frame may be a reference picture from a first reference picture list L0 or a second reference picture list L1, and may have a resolution different from that of the video frame. Then, prediction template samples may include uni-prediction template samples, which include (a) reconstructed samples above the RPR prediction samples and/or (b) reconstructed samples on the left of the RPR prediction samples (e.g., as depicted in FIG. 9).

As described above with reference to the RPR process in view of Table 2-Table 4, a RPR up-sampling filter can be applied to generate the uni-prediction samples and the uni-prediction template samples if a resolution of the video frame is greater than the resolution of the reference frame. Alternatively, with reference to the RPR process in view of Table 5-Table 7, a RPR down-sampling filter can be applied to generate the uni-prediction samples and the uni-prediction template samples if the resolution of the video frame is smaller than the resolution of the reference frame.

In another example, a bi-prediction scheme can be applied to determine the RPR prediction samples for the video block. Specifically, first RPR uni-prediction samples for the video block can be determined from a first reference frame in the first reference picture list L0 based on a first motion vector. Second RPR uni-prediction samples for the video block can be determined from a second reference frame in the second reference picture list L1 based on a second motion vector. Then, the RPR prediction samples may include bi-prediction samples, which are determined to be a weighted sum of the first RPR uni-prediction samples and the second RPR uni-prediction samples (e.g., a RPR prediction sample=w₀*a first RPR uni-prediction sample+w₁*a second RPR uni-prediction sample, where w₀ and w₁ are weighting coefficients).

Subsequently, first uni-prediction template samples may be determined, which include (a) reconstructed samples above the first RPR uni-prediction samples and/or (b) reconstructed samples on the left of the first RPR uni-prediction samples. Second uni-prediction template samples may be determined, which include (a) reconstructed samples above the second RPR uni-prediction samples and/or (b) reconstructed samples on the left of the second RPR uni-prediction samples. Then, the prediction template samples may include bi-prediction template samples, which are determined to be a weighted sum of the first uni-prediction template samples and the second uni-prediction template samples (e.g., a bi-prediction template sample=w₀*a first uni-prediction template sample+w₁*a second uni-prediction template sample).

In the bi-prediction scheme, the first reference frame may have a resolution different from that of the video frame. Alternatively, the second reference frame may have a resolution different from that of the video frame. Alternatively, each of the first and second reference frames may have a resolution different from that of the video frame. The resolution of the first reference frame may be the same as or different from the resolution of the second reference frame, which is not limited herein. As described above with reference to the RPR process in view of Table 2-Table 7, a RPR up-sampling filter or a RPR down-sampling filter can be applied to generate the first uni-prediction samples (as well as the first uni-prediction template samples), depending on whether the resolution of the video frame is greater than or smaller than the resolution of the first reference frame. Similarly, a RPR up-sampling filter or a RPR down-sampling filter can be applied to generate the second uni-prediction samples (as well as the second uni-prediction template samples), depending on whether the resolution of the video frame is greater than or smaller than the resolution of the second reference frame.

In some implementations, the template-based adaptive filter may be a linear filter. For example, the RPR prediction samples can be filtered by the template-based adaptive filter according to the following expression:

$${P}_{rpr}^{′} ( x , y ) = {\sum }_{i = - \frac{( H - 1 )}{2}}^{\frac{( H - 1 )}{2}} {\sum }_{j = - \frac{( L - 1 )}{2}}^{\frac{( L - 1 )}{2}} f ( i , j ) \times {P}_{rpr} ( x - i , y - j ) . \qquad ( 1 )$$

In the above expression (1), Pᵣₚᵣ(x, y) denotes a RPR prediction sample for a sample position (x, y); P′ᵣₚᵣ(x, y) denotes a filtered RPR prediction sample obtained by applying the template-based adaptive filter to the RPR prediction sample Pᵣₚᵣ(x, y); and f(i, j)'s denote a set of filter coefficients of the template-based adaptive filter that are applied to a H×L neighboring region of each individual prediction sample, where

$$- \frac{H - 1}{2} \leq i \leq \frac{H - 1}{2} , and$$

$$- \frac{L - 1}{2} \leq j \leq \frac{L - 1}{2} .$$

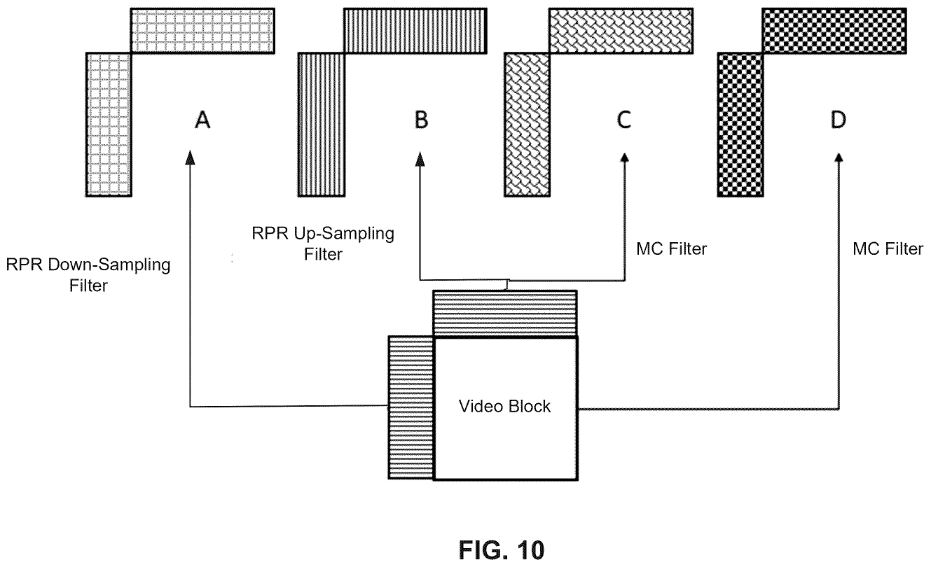

In some implementations, the set of filter coefficients can be determined based on the template samples and the prediction template samples. For example, with reference to FIG. 9, a template 904 of a video block 902 in a video frame is illustrated. Template samples in template 904 may include reconstructed samples above video block 902 and reconstructed samples on the left of video block 902 (i.e., neighboring reconstructed samples on top of video block 902 and neighboring reconstructed samples on the left of video block 902). RPR prediction samples 906 (e.g., RPR uni-prediction samples) and prediction template samples 908 (e.g., uni-prediction template samples) from a reference frame are also illustrated in FIG. 9 for video block 902. For example, prediction template samples 908 may include reconstructed samples above RPR prediction samples 906 and reconstructed samples on the left of RPR prediction samples 906. For example, prediction template samples 908 may be corresponding RPR prediction samples of the template samples based on the RPR-based motion compensation. Up-sampling or down-sampling may be applied to generate prediction template samples 908, depending on whether the resolution of the reference frame is smaller than or greater than the resolution of the video frame (e.g., as illustrated below in FIG. 10).

With reference to FIG. 9, the set of filter coefficients f(i, j)'s can be determined by filter derivation 910, which minimizes the difference between the template samples of template 904 and prediction template samples 908 to reduce the signaling overhead. For example, filter coefficients f(i, j)'s can be determined by the following expression:

$${f}^{*} = argmin {\sum }_{x} {\sum }_{y} {\vert T ( x , y ) - {T}_{rpr}^{′} ( x , y ) \vert}^{2} = \text{} argmin {\sum }_{x} {\sum }_{y} {[ ( {\sum }_{i = - \frac{( H - 1 )}{2}}^{\frac{( H - 1 )}{2}} {\sum }_{j = - \frac{( L - 1 )}{2}}^{\frac{( L - 1 )}{2}} f ( i , j ) \times {T}_{rpr} ( x - i , y - j ) ) - T ( x , y ) ]}^{2} . \qquad ( 2 )$$

In the above expression (2), T(x, y) denotes a template sample of template 904 for a sample position (x, y); and Tᵣₚᵣ(x, y) denotes a prediction template sample 908 corresponding to T(x, y). In the above expressions (1) and (2), only scaling factors are considered in the filtering process. It is contemplated that an offset term and one or more non-linear terms can also be introduced into the template-based adaptive filter to improve the coding efficiency. It is also contemplated that various template-based adaptive filters with different sizes and shapes may be applied to provide different trade-offs between coding performance and complexity. A larger-size filter can make the prediction template samples better approach to the template samples but at the expense of increased computational complexity.

Also referring to FIG. 9, after deriving the filter coefficients, adaptive filtering 912 can be applied to filter RPR prediction samples 906, so that filtered RPR prediction samples 914 can be generated. For example, the above expression (1) can be applied to generate filtered RPR prediction samples 914.

It is noted that FIG. 9 is illustrated based on an assumption that there is a single motion vector associated with the video block (i.e., uni-prediction). Consistent with some aspects of the present disclosure, template-based adaptive filtering scheme 802 of FIG. 8 can also be applied in a scenario where there are two motion vectors associated with the video block (e.g., bi-prediction).

In some implementations, template-based adaptive filtering scheme 802 can be applied in a bi-prediction scenario based on (a) RPR bi-prediction samples of the video block and (b) bi-prediction template samples of the video block. For example, the RPR bi-prediction samples and the bi-prediction template samples of the video block can be determined based on the first and second motion vectors from the first and second reference frames, respectively, as described above in more detail. Then, the set of filter coefficients f(i, j)'s can be determined based on the template samples and the bi-prediction template samples (e.g., by minimizing the difference between the bi-prediction template samples and the template samples as illustrated in the above expression (2)). Next, the derived filter coefficients f(i, j)'s can be applied to filter the RPR bi-prediction samples of the video block, as illustrated in the above expression (1), to generate filtered RPR bi-prediction samples of the video block.

In some implementations, template-based adaptive filtering scheme 802 can be applied in the bi-prediction scenario based on one or more of the following: (1) first RPR uni-prediction samples of the video block in a first prediction direction; (2) second RPR uni-prediction samples of the video block in a second prediction direction; (3) first uni-prediction template samples of the video block in the first prediction direction; and (4) second uni-prediction template samples of the video block in the second prediction direction. Without loss of generality, in the description hereinafter, the first prediction direction may refer to a prediction direction associated with the first reference picture list L0, whereas the second prediction direction may refer to a prediction direction associated with the second reference picture list L1. It is contemplated that the first prediction direction can also be the prediction direction associated with the second reference picture list L1, whereas the second prediction direction can be the prediction direction associated with the first reference picture list L0.

Specifically, the template-based adaptive filter may include a first filter for the first prediction direction and a second filter for the second prediction direction. The first RPR uni-prediction samples of the video block may be filtered based on the first filter to generate first filtered RPR prediction samples. The second RPR uni-prediction samples of the video block may be filtered based on the second filter to generate second filtered RPR prediction samples. The first filtered RPR prediction samples and the second filtered RPR prediction samples can be combined to generate the filtered RPR prediction samples.

The set of filter coefficients of the template-based adaptive filter may include a first set of filter coefficients for the first filter and a second set of filter coefficients for the second filter. The first set of filter coefficients and the second set of filter coefficients can be determined based on the template samples, the first uni-prediction template samples, and the second uni-prediction template samples, as described below in more detail.

For example, two adaptive filter operations can be applied in a unilateral manner as follows: (a) the first set and the second set of filter coefficients can be separately derived, and then applied to the first RPR uni-prediction samples and the second RPR uni-prediction samples to generate first filtered RPR uni-prediction samples and second filtered RPR uni-prediction samples, respectively; and (b) a weighted sum (e.g., an average) of the first and second filtered uni-prediction samples can be generated as filtered RPR prediction samples for the video block. For example, the following expression can be applied to generate the filtered RPR prediction samples:

$${P}_{rpr}^{′0} ( x , y ) = {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{0} ( i , j ) \times {P}_{rpr}^{0} ( x - i , y - j ) \qquad ( 3 )$$

$${P}_{rpr}^{′1} ( x , y ) = {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{1} ( i , j ) \times {P}_{rpr}^{1} ( x - i , y - j )$$

$${P}_{rpr}^{bi} ( x , y ) = {w}_{0} * {P}_{rpr}^{′0} ( x , y ) + {w}_{1} * {P}_{rpr}^{′1} ( x , y )$$

In the above expression (3), f₀(i, j)'s and f₁(i, j)'s denote the first set of filter coefficients for the first filter and the second set of filter coefficients for the second filter, respectively.

$${P}_{rpr}^{0} ( x , y ) and {P}_{rpr}^{1} ( x , y )$$

respectively denote a first RPR uni-prediction sample and a second RPR uni-prediction sample for a sample (x, y) of the video block before the first filter and the second filter are applied.

$${P}_{rpr}^{′0} ( x , y ) and {P}_{rpr}^{′1} ( x , y )$$

respectively denote a first filtered RPR uni-prediction sample and a second filtered RPR uni-prediction sample for the sample (x, y) of the video block.

Different filter derivation methods may be used to estimate the first set of filter coefficients f₀(i, j)'s and the second set of filter coefficients f₁(i, j)'s. In a first filter derivation method, the two sets of filter coefficients can be determined separately. Specifically, the first filter derivation method may include: (a) generating the first uni-prediction template samples and the second uni-prediction template samples, respectively, by performing operations like those described above; (b) determining the first set of filter coefficients f₀(i, j)'s based on the template samples and the first uni-prediction template samples, e.g., by minimizing the difference between the template samples and the first uni-prediction template samples as illustrated in the expression (2); and (c) determining the second set of filter coefficients f₁(i, j)'s based on the template samples and the second uni-prediction template samples, e.g., by minimizing the difference between the template samples and the second uni-prediction samples as shown in the expression (2).

In a second filter derivation method, an iterative scheme can be applied to alternatively determine the first set of filter coefficients f₀(i, j)'s and the second set of filter coefficients f₁(i, j)'s. For example, the second filter derivation method may alternatively optimize one of the first and second filters for one of the first and second prediction directions, while keeping another one of the first and second filters in another one of the first and second prediction directions unchanged. The second filter derivation method may include steps 1-6 described below.

In step 1, given a starting prediction direction L⁽⁰⁾, initial filter coefficients

$${f}_{{L}^{( 0 )}}^{( 0 )}$$

can be derived for the starting prediction direction by minimizing the difference (or distortion) between the uni-prediction template samples T_{L}_{⁽⁰⁾} associated with the starting prediction direction and the template samples T of the video block (e.g., as shown in the expression (2)).

In a first example, the starting prediction direction is the first prediction direction associated with the first reference picture list L0, e.g., L⁽⁰⁾=0. The uni-prediction template samples T_{L}_{⁽⁰⁾} is T₀, which are the first uni-prediction template samples in the first prediction direction. The initial filter coefficients

$${f}_{{L}^{( 0 )}}^{( 0 )} are {f}_{0}^{( 0 )} ,$$

which are initial filter coefficients for the first filter, derived by minimizing the difference between the first uni-prediction template samples T₀ and the template samples T of the video block.

In a second example, the starting prediction direction is the second prediction direction associated with the second reference picture list L1, e.g., L⁽⁰⁾=1. The uni-prediction template samples T_{L}_{⁽⁰⁾} is T₁, which are the second uni-prediction template samples in the second prediction direction. The initial filter coefficients

$${f}_{{L}^{( 0 )}}^{( 0 )} are {f}_{1}^{( 0 )} ,$$

which are initial filter coefficients for the second filter, derived by minimizing the difference between the second uni-prediction template samples T₁ and the template samples T of the video block.

In step 2, based on the initial filter coefficients

$${f}_{{L}^{( 0 )}}^{( 0 )} ,$$

the filtered uni-prediction template samples

$${T}_{{L}^{( 0 )}}^{( 0 )}$$

are calculated. An iteration parameter k is set to be 1 (e.g., k=1). For example, the filtered uni-prediction template samples

$${T}_{{L}^{( 0 )}}^{( 0 )}$$

can be generated by filtering the uni-prediction template samples T_{L}_{⁽⁰⁾} using the initial filter coefficients.

$${f}_{{L}^{( 0 )}}^{( 0 )} .$$

For instance, following the first example above, the filtered uni-prediction template samples

$${T}_{{L}^{( 0 )}}^{( 0 )}$$

are the first filtered uni-prediction template samples

$${T}_{0}^{( 0 )}$$

in the first prediction direction. For instance, following the second example above, the filtered uni-prediction template samples

$${T}_{{L}^{( 0 )}}^{( 0 )}$$

are the second filtered uni-prediction template samples

$${T}_{1}^{( 0 )}$$

in the second prediction direction.

In step 3, a target prediction direction is selected to be L^{(k)}=1−L^{(k-1)}. Target template samples T^{(k)} of the video block can be calculated by subtracting the filtered uni-prediction

$${T}_{{L}^{( k - 1 )}}^{( k - 1 )}$$

from the template samples T of the video block. For example,

$${T}^{( k )} = T - {T}_{{L}^{( k - 1 )}}^{( k - 1 )} .$$

For example, if L^{(k-1)}=0, then L^{(k)}=1, indicating that the target prediction direction is the second prediction direction. Then,

$${T}^{( k )} = T - {T}_{0}^{( k - 1 )} .$$

In another example, if L^{(k-1)}=1, then L^{(k)}=0, indicating that the target prediction direction is the first prediction direction. Then,

$${T}^{( k )} = T - {T}_{1}^{( k - 1 )} .$$

In step 4, the filter coefficients

$${f}_{{L}^{( k )}}^{( k )}$$

for the target prediction direction L^{(k)} are derived by minimizing the difference (or distortion) between the uni-prediction template samples T_{L}_{^{(k)}} in the prediction direction L^{(k)} and the target template samples T^{(k)}.

For example, if L^{(k)}=1, indicating that the target prediction direction is the second prediction direction, the filter coefficients

$${f}_{{L}^{( k )}}^{( k )}$$

are filter coefficients

$${f}_{1}^{( k )}$$

for the second filter and obtained by minimizing the difference between the second uni-prediction template samples T₁ and the target template samples T^{(k)}. In another example, if L^{(k)}=0, indicating that the target prediction direction is the first prediction direction, the filter coefficients

$${f}_{{L}^{( k )}}^{( k )}$$

are filter coefficients

$${f}_{0}^{( k )}$$

for the first filter and obtained by minimizing the difference between the first uni-prediction template samples T₀ and the target template samples T^{(k)}.

In step 5, based on the filter coefficients

$${f}_{{L}^{( k )}}^{( k )} ,$$

the filtered uni-prediction template samples

$${T}_{{L}^{( k )}}^{( k )}$$

can be calculated. For example, the filtered uni-prediction template samples

$${T}_{{L}^{( k )}}^{( k )}$$

can be generated by filtering the uni-prediction template samples T_{L}_{^{(k)}} using the filter coefficients

$${f}_{{L}^{( k )}}^{( k )} .$$

In step 6, the iteration parameter k is incremented by 1 (e.g., k=k+1). The method returns to step 3.

Iterations in the second filter derivation method may be terminated when a termination condition is satisfied. For example, when the number of iterations reaches a threshold, the second filter derivation method may be terminated. It is contemplated that different number of iterations may be applied to the second filter derivation method. In general, more iterations may lead to a smaller distortion between the template samples and the prediction template samples (i.e., better coding gain) which may come at the expense of higher computational complexity.

It is contemplated that linear terms and/or non-linear terms can be included in the template-based adaptive filter. In practice, filters with different lengths may be applied for varying the trade-off between coding performance and computational complexity. A longer filter can make the prediction template samples better approach to the template samples but at the expense of increased computational complexity. In one example, a 2-tap linear model (i.e., one scaling factor and one offset) can be used in the template-based adaptive filter.

Consistent with some aspects of the present disclosure, template-based MVD prediction scheme 804 can be applied to reduce the signaling overhead. In the VVC and its preceding standards, instead of directly signaling the motion vectors, the MVDs can be transmitted in a bitstream. The MVDs can be coded by the equal probability (EP) mode and take up a large portion of the bitstream. Template-based MVD prediction scheme 804 disclosed herein can be applied to improve the MVD coding efficiency for the RPR scenario.

On the encoder side, a basic idea of scheme 804 is to sort the possible combinations of MVD signs and most significant suffix bins of an MVD according to template costs, and then an index of the true MVD value is coded with a context model and signaled to the decoder. For example, for a motion vector associated with the video block, an MVD can be determined based on the motion vector and an MVP (e.g., MVD=motion vector-MVP). A template-based MVD reordering scheme may be applied to generate a reordered MVD candidate list. Then, an MVD index of the MVD in the reordered MVD candidate list can be determined and signaled to the decoder.

To apply the template-based MVD reordering scheme to generate the reordered MVD candidate list, initially, a list of MVD candidates can be produced based on a combination of potential MVD signs and most significant suffix bins of the MVD. For example, a list of MVD candidates can be generated based on the combination of all possible MVD signs and most significant suffix bins of the MVD. Next, template costs associated with the MVD candidates can be determined respectively. For example, for each MVD candidate in the list, a template cost associated with the MVD candidate can be determined by: (1) determining template samples of the video block; (2) determining a motion vector candidate based on the MVD candidate and the MVP; (3) determining prediction template samples of the video block from a reference frame based on the motion vector candidate; and (4) determining a metric difference (e.g., an SAD, or an SSD) between the template samples and the prediction template samples as a template cost associated with the MVD candidate. Subsequently, the MVD candidates in the list can be sorted based on their respective template costs to generate the reordered MVD candidate list. For example, the MVD candidates can be sorted in the ascending order of their respective template costs to generate the reordered MVD candidate list.

In other words, on the encoder side, template-based MVD prediction scheme 804 may include: (a) producing a list of MVD candidates based on a combination of potential MVD signs and most significant suffix bins of the MVD; (b) determining template costs associated with the MVD candidates in the list, respectively; (c) sorting the MVD candidates based on the template costs to generate the reordered MVD candidate list; (d) determining an MVD index of the MVD in the reordered MVD candidate list; and (e) signaling the MVD index to the decoder.

On the decoder side, template-based MVD prediction scheme 804 may include: (i) applying a template-based MVD reordering scheme to generate a reordered MVD candidate list; and (ii) selecting, based on an MVD index signaled by the encoder, an MVD candidate from the reordered MVD candidate list as an MVD for a motion vector. For example, the MVD can be derived at the reconstruction stage by: (a) producing a list of MVD candidates based on a combination of potential MVD signs and most significant suffix bins of the MVD; (b) determining template costs associated with the MVD candidates in the list, respectively; (c) sorting the MVD candidates based on the template costs to generate the reordered MVD candidate list; and (d) selecting an MVD candidate from the reordered MVD candidate list as the MVD for the motion vector based on an MVD index signaled by the encoder.

In template-based MVD prediction scheme 804, according to a resolution of a reference frame that an MVD candidate is associated with, different motion compensated filters may be applied to generate the prediction template samples of the video block. For example, as shown in FIG. 10, an MVD candidate A is associated with a reference picture having a different resolution from the current video frame (e.g., having a resolution greater than that of the current video frame). Then, a RPR down-sampling filter can be applied to generate the corresponding prediction template samples. In another example, an MVD candidate B in FIG. 10 is associated with another reference picture having a different resolution from the current video frame (e.g., having a resolution smaller than that of the current video frame). Then, a RPR up-sampling filter can be applied to generate the corresponding prediction template samples. On the other hand, MVD candidates C and D in FIG. 10 are associated with reference pictures with the same resolution as the current video frame. Then, default motion compensation (MC) filters (with no up-sampling and no down-sampling) can be applied to generate the corresponding prediction template samples.

Consistent with some aspects of the present disclosure, template-based reference index prediction scheme 806 may be applied to reduce the signaling overhead of reference indices for the RPR. On the encoder side, for a reference frame corresponding to a motion vector, a template-based reference index reordering scheme may be applied to generate a reordered joint list of reference pictures. Then, a reference picture index (also referred to as a reference index for simplicity) of the reference frame in the reordered joint list of reference pictures may be determined and signaled to the decoder.

In some implementations, to apply the template-based reference index reordering scheme to generate the reordered joint list of reference pictures, initially, reference pictures from a first reference picture list and reference pictures from a second reference picture list may be combined into a joint list of reference pictures. Then, motion vector candidates can be generated based on the MVD and MVPs generated from reference pictures in the joint list. Next, template costs associated with the reference pictures in the joint list can be determined based on the motion vector candidates, respectively. For example, for each motion vector candidate associated with a reference picture in the list, a template cost associated with the motion vector candidate can be determined by: (1) determining template samples of the video block; (2) determining prediction template samples of the video block from the reference picture based on the motion vector candidate; and (3) determining a metric difference (e.g., an SAD, or an SSD) between the template samples and the prediction template samples as a template cost associated with the reference picture. Subsequently, the reference pictures in the joint list can be sorted based on their respective template costs to generate the reordered joint list. For example, the reference pictures in the joint list can be sorted according to the ascending order of their respective template costs to generate the reordered joint list.

In some examples, for the inter AMVP mode, the reference pictures in the first reference picture list L0 and the reference pictures in the second reference picture list L1 can be combined to generate a joint list. Then, a group of the motion vector candidates can be generated by the combination of the MVD and the AMVP predictors that are generated from the reference pictures in the joint list. A respective template cost can be calculated for each motion vector candidate associated with a respective reference picture. Afterwards, the joint list is reordered based on the ascending order of the template costs associated with the reference pictures, respectively. The index of the selected reference picture (which is the reference frame associated with the MVD) in the reordered list is signaled in the bitstream. For the bi-prediction AMVP mode, a list of pairs of reference pictures from the first reference picture list L0 and the second reference picture list L1 can be generated. The pairs of reference pictures can be similarly reordered based on respective template costs associated with the pairs of reference pictures. An index of the selected pair of reference pictures (which are the reference frames associated with two MVDs of two motion vectors of the video block, respectively) is signaled to the decoder.

In some other implementations, to apply the template-based reference index reordering scheme to generate the reordered joint list of reference pictures, initially, reference pictures from a first reference picture list and reference pictures from a second reference picture list can be divided into one or more groups of reference pictures. Then, one or more reordered lists of reference pictures can be generated by applying the template-based reference index reordering scheme to each group of reference pictures to generate a corresponding reordered list of reference pictures. Next, the one or more reordered lists of reference pictures can be combined to generate the reordered joint list of reference pictures.

For example, as discussed above, temporal reference pictures with different resolutions may present varying characteristics which may lead to significant quality variations of the prediction samples generated from different pictures. With the consideration of such a phenomenon, a group-based reference index prediction scheme can be applied. Specifically, the reference pictures in the first reference picture list L0 and the reference pictures in the second reference picture list L1 are divided into two groups. The first group includes reference pictures from the list L0 and reference pictures from the list L1 that have the same resolution as the current video frame. The second group includes reference pictures from the list L0 and reference pictures from the list L1 each of which has a resolution different from that of the current video frame. Then, the template-based reference index reordering scheme can be applied to reorder the two groups of reference pictures separately in the ascending order of their respective template costs. Afterwards, the two reordered groups of reference pictures are combined to form a reordered joint list of reference pictures. The index of the selected reference picture (which is the reference frame associated with the motion vector of the video block) in the reordered joint list is signaled from the encoder to the decoder.

The first ordered group of reference pictures (i.e., the reference pictures with the same resolution as the current video frame) may be placed ahead of the second ordered group of reference pictures (i.e., the reference pictures with different resolutions to the current video frame) in the reordered joint list. Alternatively, the second ordered group of reference pictures may be placed ahead of the first ordered group of reference pictures.

In another example, the reference pictures from lists L0 and L1 can be grouped according to their respective resolutions, such that reference pictures with the same resolution can be placed into the same group. Then, the template-based reference index reordering scheme may be applied to each group of reference pictures separately. Afterwards, all the reordered groups of reference pictures can be combined to form the reordered joint list of reference pictures. Different orders may be applied when combining different reordered groups of reference pictures into the reordered joint list. For instance, the reordered groups of reference pictures are combined according to the resolutions of the different groups, such that a reordered group with a smaller resolution difference from the current video frame can be placed ahead of another reordered group with a larger resolution difference from the current video frame.

On the decoder side, template-based reference index prediction scheme 806 may include, for a reference frame corresponding to a motion vector, (i) applying a template-based reference index reordering scheme to generate a reordered joint list of reference pictures, and (ii) selecting, based on a reference picture index signaled by the encoder, a reference picture from the reordered joint list as the reference frame for the motion vector. The reordered joint list of reference pictures may be generated by performing operations like those described above with reference to the encoder side, and the similar description will not be repeated herein.

Consistent with some aspects of the present disclosure, template-based merge index reordering scheme 808 may be applied to reduce the signaling overhead of the merge index. Similar to the inter AMVP mode, a candidate list in the merge mode may include merge candidates that are associated with the temporal reference pictures with different resolutions. Due to the varying statistical characteristics of different RPR reference pictures, template-based merge index reordering scheme 808 can be applied to reduce the signaling overhead.

On the encoder side, for each motion vector corresponding to a respective MVP, template-based merge index reordering scheme 808 may be applied to generate a reordered merge list of merge candidates. For example, the following operations may be performed to generate the reordered merge list of merge candidates, including: (a) producing a list of merge candidates; (b) determining template costs associated with the merge candidates in the list, respectively; and (c) sorting the merge candidates in the list based on the template costs to generate the reordered merge list of merge candidates. Then, a merge index of a merge candidate corresponding to the respective MVP in the reordered merge list may be determined and signaled to the decoder.

In some implementations, an initial merge candidate list can be constructed according to a merge list generation process described above with reference to the inter merge mode to include spatial MVPs, temporal MVPs, non-adjacent MVPs, history-based MVPs, pairwise average MVPs, and zero MVPs as MVP candidates in the list. Next, the MVP candidates in the initial merge candidate list can be reordered according to their template costs. The index of the selected merge candidate (which is an MVP associated with a motion vector of the video block) in the reordered candidate list is signaled from the encoder to the decoder. Like FIG. 10, based on the resolution of the reference picture associated with a corresponding merge candidate, either RPR up-sampling or down-sampling filters or default motion compensated filters may be applied to generate prediction template samples from the reference picture.

On the decoder side, to determine an MVP associated with a motion vector, template-based merge index reordering scheme 808 may be applied to generate a reordered merge list of merge candidates at least by: (a) producing a list of merge candidates; (b) determining template costs associated with the merge candidates in the list, respectively; and (c) sorting the merge candidates in the list based on the template costs to generate the reordered merge list of merge candidates. Then, a merge candidate from the reordered merge list is selected as the MVP for the motion vector based on a merge index signaled by the encoder.

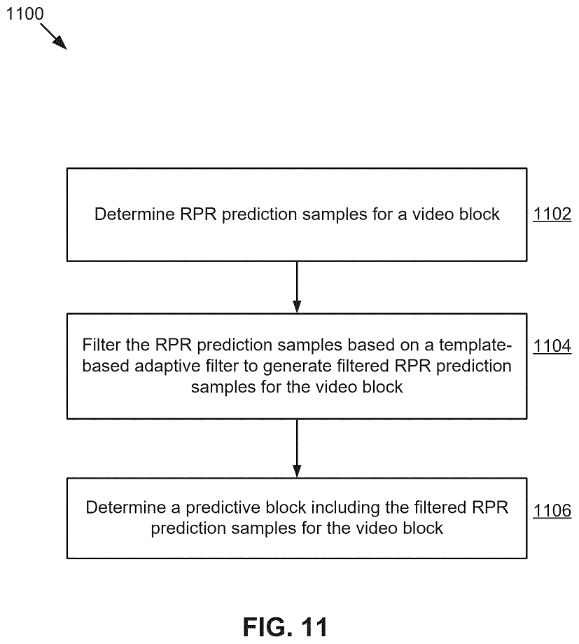

FIG. 11 is a flow chart of an exemplary method 1100 for video coding based on template-based coding schemes in accordance with some implementations of the present disclosure. Method 1100 may be implemented by a processor associated with video encoder 20 or video decoder 30 (e.g., method 1100 may be implemented on the encoder side or the decoder side), and may include steps 1102-1106 as described below. Some of the steps may be optional to perform the disclosure provided herein. Further, some of the steps may be performed simultaneously, or in a different order than shown in FIG. 11.

In step 1102, as shown in FIG. 11, the processor may determine RPR prediction samples for a video block from a video frame of a video. For example, the processor may determine the RPR prediction samples based on one or more reference frames and motion information associated with the video block. The motion information may include at least one or more motion vectors and one or more reference picture indices corresponding to the one or more reference frames, respectively. At least one of the one or more reference frames has a resolution different from a resolution of the video frame.

In some implementations, a uni-prediction scheme or a bi-prediction scheme is applied to determine the RPR prediction samples for the video block. The processor may perform operations like those described above with reference to FIG. 8 to determine the RPR prediction samples, and the similar description will not be repeated herein.

In step 1104, the processor may filter the RPR prediction samples based on a template-based adaptive filter to generate filtered RPR prediction samples for the video block. For example, template-based adaptive filtering scheme 802 described above with reference to FIG. 8 can be applied to generate the filtered RPR prediction samples for the video block, and the similar description will not be repeated herein.

In step 1106, the processor may determine a predictive block including the filtered RPR prediction samples for the video block. On the encoder side, the predictive block may be used to generate a bitstream as described above with reference to FIG. 2. In another example, on the decoder side, a bitstream can be decoded based on the generated predictive block as described above with reference to FIG. 3.

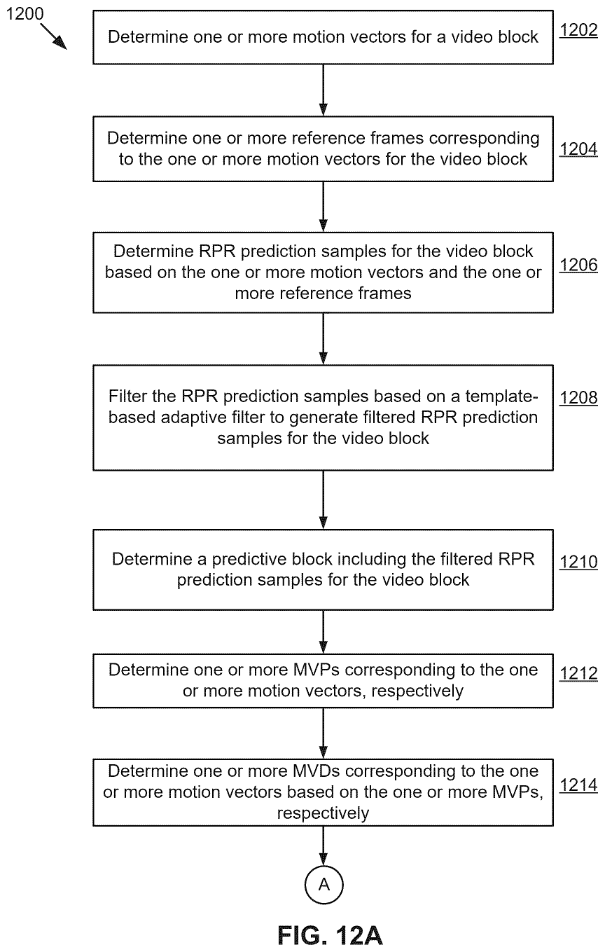

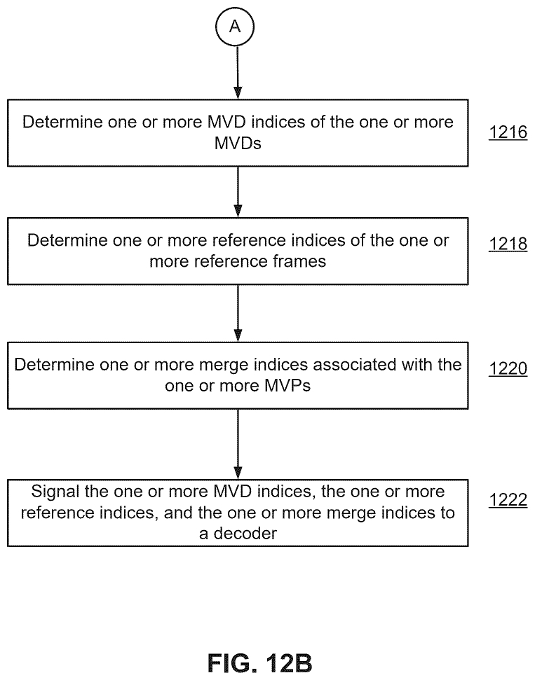

FIGS. 12A and 12B together show a flow chart of an exemplary method 1200 for video encoding based on template-based coding schemes in accordance with some implementations of the present disclosure. Method 1200 may be implemented by a processor associated with video encoder 20, and may include steps 1202-1222 as described below. Some of the steps may be optional to perform the disclosure provided herein. Further, some of the steps may be performed simultaneously, or in a different order than shown in FIGS. 12A and 12B.

In step 1202, as shown in FIG. 12A, the processor may determine one or more motion vectors for a video block from a video frame of a video. For example, if a uni-prediction scheme is applied in the video coding, the processor may determine a motion vector for the video block by performing operations like those described above with reference to motion estimation unit 42 of FIG. 2. Alternatively, if a bi-prediction scheme is applied in the video coding, the processor may determine a first motion vector in a first prediction direction and a second motion vector in a second prediction direction for the video block, by performing operations like those described above with reference to motion estimation unit 42 of FIG. 2. The similar description will not be repeated herein.

In step 1204, as shown in FIG. 12A, the processor may determine one or more reference frames corresponding to the one or more motion vectors for the video block. For example, if a uni-prediction scheme is applied in the video coding, the processor may determine a reference frame corresponding to a motion vector of the video block from either the first reference picture list L0 or the second reference picture list L1. Motion information can be generated to include the motion vector and a reference picture index associated with the reference frame.

Alternatively, if a bi-prediction scheme is applied in the video coding, the processor may determine a first reference frame associated with a first motion vector from the first reference picture list L0 and a second reference frame associated with a second motion vector from the second reference picture list L1 for the video block. Motion information can be generated to include the first motion vector, the second motion vector, a first reference picture index associated with the first reference frame, and a second reference picture index associated with the second reference frame.

In step 1206, as shown in FIG. 12A, the processor may determine RPR prediction samples for the video block based on the one or more motion vectors and the one or more reference frames. The processor may perform operations like those described above with reference to FIG. 8 to determine the RPR prediction samples, and the similar description will not be repeated herein.

In step 1208, as shown in FIG. 12A, the processor may filter the RPR prediction samples based on a template-based adaptive filter to generate filtered RPR prediction samples for the video block. For example, template-based adaptive filtering scheme 802 described above with reference to FIG. 8 can be applied to generate the filtered RPR prediction samples for the video block, and the similar description will not be repeated herein.

In step 1210, as shown in FIG. 12A, the processor may determine a predictive block including the filtered RPR prediction samples for the video block.

In step 1212, as shown in FIG. 12A, the processor may determine one or more MVPs corresponding to the one or more motion vectors, respectively. For example, the processor may determine the one or more MVPs as one or more merge candidates from a merge candidate list.

In step 1214, as shown in FIG. 12A, the processor may determine one or more MVDs corresponding to the one or more motion vectors based on the one or more MVPs, respectively. For example, for each motion vector, a corresponding MVD can be a difference between the motion vector and a corresponding MVP.

Referring to FIG. 12B, in step 1216, the processor may determine one or more MVD indices of the one or more MVDs, respectively. For example, for each MVD, the processor may apply a template-based MVD reordering scheme to generate a reordered MVD candidate list at least by: (a) producing a list of MVD candidates based on a combination of potential MVD signs and most significant suffix bins of the MVD; (b) determining template costs associated with the MVD candidates, respectively; and (c) sorting the MVD candidates based on the template costs to generate the reordered MVD candidate list. The processor may determine an MVD index of the MVD in the reordered MVD candidate list.

In some implementations, operations like those described above with reference to template-based MVD prediction scheme 804 of FIG. 8 can be performed to determine the one or more indices of the one or more MVDs, respectively. The similar description will not be repeated herein.

In step 1218, as shown in FIG. 12B, the processor may determine one or more reference indices of the one or more reference frames, respectively. For example, for a reference frame corresponding to a motion vector, the processor may apply a template-based reference index reordering scheme to generate a reordered joint list of reference pictures, and determine a reference picture index of the reference frame in the reordered joint list.

In some implementations, to generate the reordered joint list of reference pictures, the processor may combine reference pictures from a first reference picture list and reference pictures from a second reference picture list into a joint list of reference pictures. The processor may generate motion vector candidates based on the MVD and MVPs generated from reference pictures in the joint list. The processor may determine template costs associated with the reference pictures in the joint list based on the motion vector candidates, respectively. The processor may sort the reference pictures in the joint list based on the template costs to generate the reordered joint list.

In some implementations, to generate the reordered joint list of reference pictures, the processor may divide reference pictures from a first reference picture list and reference pictures from a second reference picture list into one or more groups of reference pictures. The processor may generate one or more reordered lists of reference pictures by applying the template-based reference index reordering scheme to each group of reference pictures to generate a corresponding reordered list of reference pictures. The processor may combine the one or more reordered lists of reference pictures to generate the reordered joint list of reference pictures.

In some implementations, operations like those described above with reference to template-based reference index prediction scheme 806 of FIG. 8 can be performed to determine the one or more reference indices of the one or more reference frames, respectively. The similar description will not be repeated herein.

In step 1220, as shown in FIG. 12B, the processor may determine one or more merge indices associated with the one or more MVPs, respectively. For example, for each MVP corresponding to a respective motion vector, the processor may apply a template-based merge index reordering scheme to generate a reordered merge list of merge candidates at least by: (a) producing a list of merge candidates; (b) determining template costs associated with the merge candidates in the list, respectively; and (c) sorting the merge candidates in the list based on the template costs to generate the reordered merge list of merge candidates. The processor may determine a merge index of a merge candidate (which corresponds to the MVP) in the reordered merge list.

In some implementations, operations like those described above with reference to template-based merge index reordering scheme 808 of FIG. 8 can be performed to determine the one or more merge indices. The similar description will not be repeated herein.

In step 1222, as shown in FIG. 12B, the processor may signal the one or more MVD indices, the one or more reference indices, and the one or more merge indices to a decoder.

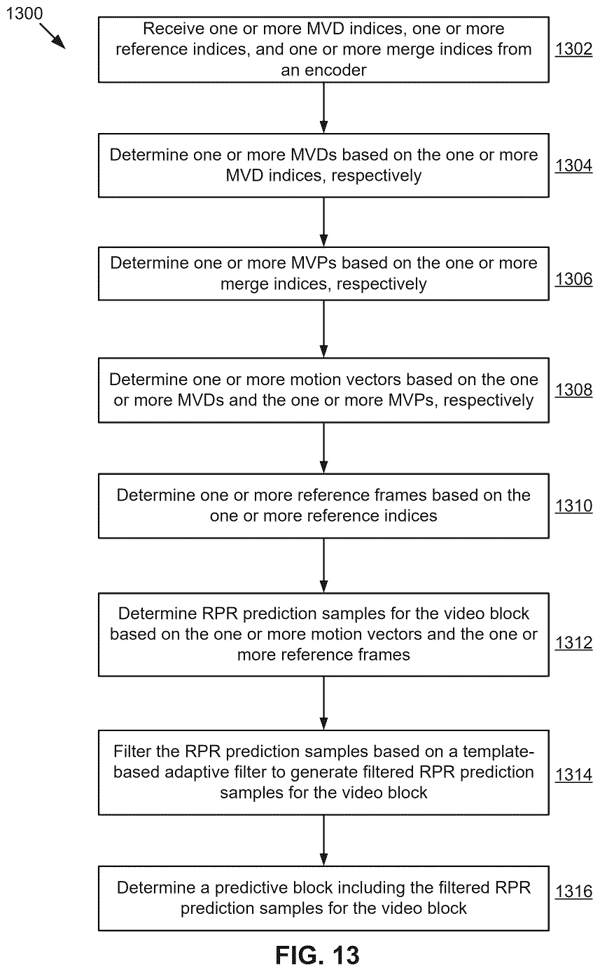

FIG. 13 is a flow chart of an exemplary method 1300 for video decoding based on template-based coding schemes in accordance with some implementations of the present disclosure. Method 1300 may be implemented by a processor associated with video decoder 30, and may include steps 1302-1316 as described below. Some of the steps may be optional to perform the disclosure provided herein. Further, some of the steps may be performed simultaneously, or in a different order than shown in FIG. 13.

In step 1302, as shown in FIG. 13, the processor may receive one or more MVD indices, one or more reference indices, and one or more merge indices from an encoder. For example, the processor may receive the one or more MVD indices, the one or more reference indices, and the one or more merge indices through a bitstream sent by the encoder.

In step 1304, as shown in FIG. 13, the processor may determine one or more MVDs based on the one or more MVD indices, respectively. For example, for each MVD corresponding to a motion vector, the processor may apply a template-based MVD reordering scheme to generate a reordered MVD candidate list at least by: (a) producing a list of MVD candidates based on a combination of potential MVD signs and most significant suffix bins; (b) determining template costs associated with the MVD candidates, respectively; and (c) sorting the MVD candidates based on the template costs to generate the reordered MVD candidate list. The processor may select an MVD candidate from the reordered MVD candidate list as the MVD for the motion vector based on a corresponding MVD index signaled by the encoder.

In some implementations, operations like those described above with reference to template-based MVD prediction scheme 804 of FIG. 8 can be performed to determine the one or more MVDs based on the one or more MVD indices, respectively. The similar description will not be repeated herein.

In step 1306, as shown in FIG. 13, the processor may determine one or more MVPs based on the one or more merge indices, respectively. For example, for each MVP corresponding to a respective motion vector, the processor may apply a template-based merge index reordering scheme to generate a reordered merge list of merge candidates at least by: (a) producing a list of merge candidates; (b) determining template costs associated with the merge candidates in the list, respectively; and (c) sorting the merge candidates in the list based on the template costs to generate the reordered merge list of merge candidates. The processor may select a merge candidate from the reordered merge list as the MVP for the respective motion vector based on a corresponding merge index signaled by the encoder.

In some implementations, operations like those described above with reference to template-based merge index reordering scheme 808 of FIG. 8 can be performed to determine the one or more merge indices. The similar description will not be repeated herein.

In step 1308, as shown in FIG. 13, the processor may determine one or more motion vectors based on the one or more MVDs and the one or more MVPs, respectively.

In step 1310, as shown in FIG. 13, the processor may determine one or more reference frames based on the one or more reference indices, respectively. For example, for each reference frame corresponding to a respective motion vector, the processor may apply a template-based reference index reordering scheme to generate a reordered joint list of reference pictures, and select a reference picture from the reordered joint list as the reference frame for the motion vector based on a corresponding reference picture index signaled by the encoder.

In some implementations, operations like those described above with reference to template-based reference index prediction scheme 806 of FIG. 8 can be performed to determine the one or more reference indices of the one or more reference frames, respectively. The similar description will not be repeated herein.

In step 1312, as shown in FIG. 13, the processor may determine RPR prediction samples for the video block based on the one or more motion vectors and the one or more reference frames. The processor may perform operations like those described above with reference to FIG. 8 to determine the RPR prediction samples, and the similar description will not be repeated herein.

In step 1314, as shown in FIG. 13, the processor may filter the RPR prediction samples based on a template-based adaptive filter to generate filtered RPR prediction samples for the video block. For example, template-based adaptive filtering scheme 802 described above with reference to FIG. 8 can be applied to generate the filtered RPR prediction samples for the video block, and the similar description will not be repeated herein.

In step 1316, as shown in FIG. 13, the processor may determine a predictive block including the filtered RPR prediction samples for the video block.

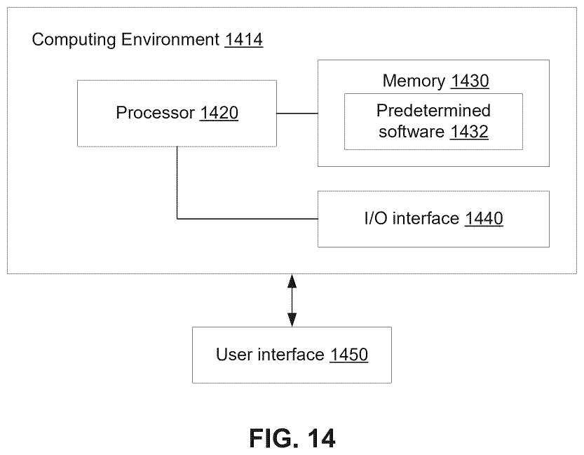

FIG. 14 shows a computing environment 1414 coupled with a user interface 1450. The computing environment 1414 can be part of a data processing server. The computing environment 1414 includes a processor 1420, a memory 1430, and an Input/Output (I/O) interface 1440.

The processor 1420 typically controls overall operations of the computing environment 1414, such as the operations associated with display, data acquisition, data communications, and image processing. The processor 1420 may include one or more processors to execute instructions to perform all or some of the steps in the above-described methods. Moreover, the processor 1420 may include one or more modules that facilitate the interaction between the processor 1420 and other components. The processor may be a Central Processing Unit (CPU), a microprocessor, a single chip machine, a Graphical Processing Unit (GPU), or the like.

The memory 1430 is configured to store various types of data to support the operation of the computing environment 1414. The memory 1430 may include predetermined software 1432. Examples of such data includes instructions for any applications or methods operated on the computing environment 1414, video datasets, image data, etc. The memory 1430 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 1440 provides an interface between the processor 1420 and peripheral interface modules, such as a keyboard, a click wheel, buttons, and the like. The buttons may include but are not limited to, a home button, a start scan button, and a stop scan button. The I/O interface 1440 can be coupled with an encoder or decoder.

In an embodiment, there is also provided a non-transitory computer-readable storage medium comprising a plurality of programs, for example, in the memory 1430, executable by the processor 1420 in the computing environment 1414, for performing the above-described methods and/or storing a bitstream generated by the encoding method described above or a bitstream to be decoded by the decoding method described above. In one example, the plurality of programs may be executed by the processor 1420 in the computing environment 1414 to receive (for example, from the video encoder 20 in FIG. 2) a bitstream or data stream including encoded video information (for example, video blocks representing encoded video frames, and/or associated one or more syntax elements, etc.), and may also be executed by the processor 1420 in the computing environment 1414 to perform the decoding method described above according to the received bitstream or data stream. In another example, the plurality of programs may be executed by the processor 1420 in the computing environment 1414 to perform the encoding method described above to encode video information (for example, video blocks representing video frames, and/or associated one or more syntax elements, etc.) into a bitstream or data stream, and may also be executed by the processor 1420 in the computing environment 1414 to transmit the bitstream or data stream (for example, to the video decoder 30 in FIG. 3). Alternatively, the non-transitory computer-readable storage medium may have stored therein a bitstream or a data stream comprising encoded video information (for example, video blocks representing encoded video frames, and/or associated one or more syntax elements etc.) generated by an encoder (for example, the video encoder 20 in FIG. 2) using, for example, the encoding method described above for use by a decoder (for example, the video decoder 30 in FIG. 3) in decoding video data. The non-transitory computer-readable storage medium may be, for example, a ROM, a Random Access Memory (RAM), a CD-ROM, a magnetic tape, a floppy disc, an optical data storage device or the like.

In an embodiment, there is provided a bitstream generated by the encoding method described above or a bitstream to be decoded by the decoding method described above. In an embodiment, there is provided a bitstream comprising encoded video information generated by the encoding method described above or encoded video information to be decoded by the decoding method described above.

In an embodiment, the is also provided a computing device comprising one or more processors (for example, the processor 1420); and the non-transitory computer-readable storage medium or the memory 1430 having stored therein a plurality of programs executable by the one or more processors, wherein the one or more processors, upon execution of the plurality of programs, are configured to perform the above-described methods.

In an embodiment, there is also provided a computer program product having instructions for storage or transmission of a bitstream comprising encoded video information generated by the encoding method described above or encoded video information to be decoded by the decoding method described above. In an embodiment, there is also provided a computer program product comprising a plurality of programs, for example, in the memory 1430, executable by the processor 1420 in the computing environment 1414, for performing the above-described methods. For example, the computer program product may include the non-transitory computer-readable storage medium.

In an embodiment, the computing environment 1414 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

In an embodiment, there is also provided a method of storing a bitstream, comprising storing the bitstream on a digital storage medium, wherein the bitstream comprises encoded video information generated by the encoding method described above or encoded video information to be decoded by the decoding method described above.

In an embodiment, there is also provided a method for transmitting a bitstream generated by the encoder described above. In an embodiment, there is also provided a method for receiving a bitstream to be decoded by the decoder described above.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A method for video decoding, comprising:
determining, by a decoder, reference-picture-resampling (RPR) prediction samples for a video block from a video frame of a video based on one or more reference frames and motion information associated with the video block, wherein at least one of the one or more reference frames has a resolution different from a resolution of the video frame; and
filtering, by the decoder, the RPR prediction samples based on a template-based adaptive filter to generate filtered RPR prediction samples for the video block; and
determining, by the decoder, a predictive block comprising the filtered RPR prediction samples for the video block.

2. The method of claim 1, wherein the template-based adaptive filter comprises a set of filter coefficients, and the method further comprises:
determining template samples associated with the video block;
determining prediction template samples corresponding to the template samples from the one or more reference frames based on the motion information; and
determining the set of filter coefficients based on the template samples and the prediction template samples.

3. The method of claim 2, wherein:
a uni-prediction scheme is applied to determine the RPR prediction samples for the video block;
determining the prediction template samples comprises:
determining uni-prediction template samples corresponding to the template samples from a reference frame based on the motion information; and
determining the set of filter coefficients comprises:
determining the set of filter coefficients based on the template samples and the uni-prediction template samples.

4. The method of claim 2, wherein:
a bi-prediction scheme is applied to determine the RPR prediction samples for the video block;
the one or more reference frames comprise a first reference frame in a first prediction direction and a second reference frame in a second prediction direction; and
the motion information comprises first motion information associated with the first reference frame and second motion information associated with the second reference frame.

5. The method of claim 4, wherein:
determining the prediction template samples comprises:
determining bi-prediction template samples corresponding to the template samples from the first and second reference frames based on the first and second motion information; and
determining the set of filter coefficients comprises:
determining the set of filter coefficients based on the template samples and the bi-prediction template samples.

6. The method of claim 4, wherein the template-based adaptive filter comprises a first filter for the first prediction direction and a second filter for the second prediction direction, and determining the RPR prediction samples for the video block comprises:
determining first RPR uni-prediction samples from the first reference frame based on the first motion information; and
determining second RPR uni-prediction samples from the second reference frame based on the second motion information.

7. The method of claim 6, wherein filtering the RPR prediction samples based on the template-based adaptive filter to generate the filtered RPR prediction samples for the video block comprises:
filtering the first RPR uni-prediction samples based on the first filter to generate first filtered RPR prediction samples;
filtering the second RPR uni-prediction samples based on the second filter to generate second filtered RPR prediction samples; and
combining the first filtered RPR prediction samples and the second RPR prediction samples to generate the filtered RPR prediction samples.

8. The method of claim 6, wherein:
the set of filter coefficients comprises a first set of filter coefficients for the first filter and a second set of filter coefficients for the second filter;
determining the prediction template samples comprises:
determining first uni-prediction template samples from the first reference frame based on the first motion information; and
determining second uni-prediction template samples from the second reference frame based on the second motion information; and
determining the set of filter coefficients comprises:
determining the first set of filter coefficients and the second set of filter coefficients based on the template samples, the first uni-prediction template samples, and the second uni-prediction template samples.

9. The method of claim 8, wherein determining the first set of filter coefficients and the second set of filter coefficients comprises:
determining the first set of filter coefficients based on the template samples and the first uni-prediction template samples; and
determining the second set of filter coefficients based on the template samples and the second uni-prediction template samples.

10. The method of claim 8, wherein determining the first set of filter coefficients and the second set of filter coefficients comprises:
applying an iterative scheme to alternatively determine the first set of filter coefficients and the second set of filter coefficients.

11. The method of claim 1, further comprising:
determining the motion information for the video block, wherein the motion information comprises at least one or more motion vectors and one or more reference picture indices; and
determining the one or more reference frames corresponding to the one or more reference picture indices for the video block.

12. The method of claim 11, wherein determining the motion information for the video block comprises:
determining one or more motion vector differences (MVDs) corresponding to the one or more motion vectors, respectively;
determining one or more motion vector predictors (MVPs) corresponding to the one or more motion vectors, respectively; and
determining the one or more motion vectors based on the one or more MVDs and the one or more MVPs, respectively.

13. The method of claim 12, wherein determining the one or more MVDs corresponding to the one or more motion vectors, respectively, comprises:
for each motion vector from the one or more motion vectors,
applying a template-based MVD reordering scheme to generate a reordered MVD candidate list; and
selecting an MVD candidate from the reordered MVD candidate list as an MVD for the motion vector based on an MVD index signaled by an encoder.

14. The method of claim 13, wherein applying the template-based MVD reordering scheme to generate the reordered MVD candidate list comprises:
producing a list of MVD candidates based on a combination of potential MVD signs and most significant suffix bins;
determining template costs associated with the MVD candidates, respectively; and
sorting the MVD candidates based on the template costs to generate the reordered MVD candidate list.

15. The method of claim 13, wherein determining the one or more reference frames for the video block comprises:
for a reference frame corresponding to the motion vector,
applying a template-based reference index reordering scheme to generate a reordered joint list of reference pictures; and
selecting a reference picture from the reordered joint list as the reference frame for the motion vector based on a reference picture index signaled by an encoder.

16. The method of claim 15, wherein applying the template-based reference index reordering scheme to generate the reordered joint list of reference pictures comprises:
combining reference pictures from a first reference picture list and reference pictures from a second reference picture list into a joint list of reference pictures; generating motion vector candidates based on the MVD and MVPs generated from reference pictures in the joint list; determining template costs associated with the reference pictures in the joint list based on the motion vector candidates, respectively; and sorting the reference pictures in the joint list based on the template costs to generate the reordered joint list; or
dividing reference pictures from a first reference picture list and reference pictures from a second reference picture list into one or more groups of reference pictures; generating one or more reordered lists of reference pictures by applying the template-based reference index reordering scheme to each group of reference pictures to generate a corresponding reordered list of reference pictures; and combining the one or more reordered lists of reference pictures to generate the reordered joint list of reference pictures.

17. The method of claim 11, wherein determining the motion information for the video block comprises:
applying a template-based merge index reordering scheme to generate the reordered merge list of merge candidates; and
selecting a merge candidate from the reordered merge list to generate the motion information of the video block based on a merge index signaled by an encoder,
wherein applying the template-based merge index reordering scheme to generate the reordered merge list of merge candidates comprises:
producing a list of merge candidates;
determining template costs associated with the merge candidates in the list, respectively; and
sorting the merge candidates in the list based on the template costs to generate the reordered merge list of merge candidates.

18. An apparatus for video coding, comprising:
a non-transitory computer readable medium; and
a processor, configured to perform an encoding method to generate a bitstream, and store the bitstream, wherein the encoding method comprises determining reference-picture-resampling (RPR) prediction samples for a video block from a video frame of a video based on one or more reference frames and motion information associated with the video block, wherein at least one of the one or more reference frames has a resolution different from a resolution of the video frame; filtering the RPR prediction samples based on a template-based adaptive filter to generate filtered RPR prediction samples for the video block; and determining a predictive block comprising the filtered RPR prediction samples for the video block,
wherein the bitstream is stored in the non-transitory computer readable medium.

19. A non-transitory computer-readable storage medium having stored therein instructions which, when executed by a processor, causes the process to perform the method for video decoding according to claim 1.

20. A method for video encoding, comprising:
determining, by an encoder, reference-picture-resampling (RPR) prediction samples for a video block from a video frame of a video based on one or more reference frames and motion information associated with the video block, wherein at least one of the one or more reference frames has a resolution different from a resolution of the video frame; and
filtering, by the encoder, the RPR prediction samples based on a template-based adaptive filter to generate filtered RPR prediction samples for the video block; and
determining, by the encoder, a predictive block comprising the filtered RPR prediction samples for the video block.
